(19) United States
(12) Patent Application Publication
(10) Pub. No.: US 2026/0205862 A1
(43) Pub. Date: Jul. 16, 2026

(54) USER-EQUIPMENT-TO-USER-EQUIPMENT RELAYING AND QUALITY OF SERVICE SPLITTING

(71) Applicant: QUALCOMM Incorporated, San Diego, CA (US)

(72) Inventors: Karthika PALADUGU, Hyderabad (IN); Jianhua LIU, Beijing (CN); Hong CHENG, Basking Ridge, NJ (US)

(21) Appl. No.: 19/127,990

(22) PCT Filed: Feb. 3, 2023
(86) PCT No.: PCT/CN2023/074365

§ 371 Date: May 7, 2025

(51) Int. Cl. H04W 28/02; H04L 47/10; H04W 88/04

(52) U.S. Cl. CPC H04W 28/0215; H04L 47/18; H04W 28/0268; H04W 88/04

(57) ABSTRACT

Various aspects of the present disclosure generally relate to wireless communication. In some aspects, a relay user equipment (UE) may receive, from a source UE, an end-to-end (E2E) quality of service associated with a link between the source UE and a destination UE. The relay UE may identify, based at least in part on the E2E quality of service, a first per-hop quality of service to be used for a link between the source UE and the relay UE, and a second per-hop quality of service to be used for one or more other links. The relay UE may transmit an indication of the first per-hop quality of service or the second per-hop quality of service. Numerous other aspects are described.

### FIELD OF THE DISCLOSURE

Aspects of the present disclosure generally relate to wireless communication and to techniques and apparatuses for user-equipment-to-user-equipment relaying and quality of service splitting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a relay user equipment (UE). The method may include receiving, from a source UE, an end-to-end (E2E) quality of service associated with a link between the source UE and a destination UE. The method may include identifying, based at least in part on the E2E quality of service, a first per-hop quality of service to be used for a link between the source UE and the relay UE, and a second per-hop quality of service to be used for one or more other links. The method may include transmitting an indication of the first per-hop quality of service or the second per-hop quality of service.

Some aspects described herein relate to a method of wireless communication performed by a remote UE. The method may include transmitting, to a relay UE, an E2E quality of service associated with a link between the remote UE and another remote UE and a route identifier associated with the link between the remote UE and the other remote UE. The method may include receiving, from the relay UE, a per-hop quality of service associated with a link between the remote UE and the relay UE. The method may include providing, by a proximity services layer of the remote UE to an access stratum layer of the remote UE, the per-hop quality of service.

Some aspects described herein relate to an apparatus for wireless communication at a relay UE. The apparatus may include a memory and one or more processors coupled to the memory. The one or more processors may be configured to receive, from a source UE, an E2E quality of service associated with a link between the source UE and a destination UE. The one or more processors may be configured to identify, based at least in part on the E2E quality of service, a first per-hop quality of service to be used for a link between the source UE and the relay UE, and a second per-hop quality of service to be used for one or more other links. The one or more processors may be configured to transmit an indication of the first per-hop quality of service or the second per-hop quality of service.

Some aspects described herein relate to an apparatus for wireless communication at a remote UE. The apparatus may include a memory and one or more processors coupled to the memory. The one or more processors may be configured to transmit, to a relay UE, an E2E quality of service associated with a link between the remote UE and another remote UE and a route identifier associated with the link between the remote UE and the other remote UE. The one or more processors may be configured to receive, from the relay UE, a per-hop quality of service associated with a link between the remote UE and the relay UE. The one or more processors may be configured to provide the per-hop quality of service.

Some aspects described herein relate to a non-transitory computer-readable medium that stores a set of instructions for wireless communication by a relay UE. The set of instructions, when executed by one or more processors of the UE, may cause the UE to receive, from a source UE, an E2E quality of service associated with a link between the source UE and a destination UE. The set of instructions, when executed by one or more processors of the UE, may cause the UE to identify, based at least in part on the E2E quality of service, a first per-hop quality of service to be used for a link between the source UE and the relay UE, and a second per-hop quality of service to be used for one or more other links. The set of instructions, when executed by one or more processors of the UE, may cause the UE to transmit an indication of the first per-hop quality of service or the second per-hop quality of service.

Some aspects described herein relate to a non-transitory computer-readable medium that stores a set of instructions for wireless communication by a remote UE. The set of instructions, when executed by one or more processors of the remote UE, may cause the remote UE to transmit, to a relay UE, an E2E quality of service associated with a link between the remote UE and another remote UE and a route identifier associated with the link between the remote UE and the other remote UE. The set of instructions, when executed by one or more processors of the remote UE, may cause the remote UE to receive, from the relay UE, a per-hop quality of service associated with a link between the remote UE and the relay UE. The set of instructions, when executed by one or more processors of the remote UE, may cause the remote UE to provide the per-hop quality of service.

Some aspects described herein relate to an apparatus for wireless communication. The apparatus may include means for receiving, from a source UE, an E2E quality of service associated with a link between the source UE and a destination UE. The apparatus may include means for identifying, based at least in part on the E2E quality of service, a first per-hop quality of service to be used for a link between the source UE and the apparatus, and a second per-hop quality of service to be used for one or more other links. The apparatus may include means for transmitting an indication of the first per-hop quality of service or the second per-hop quality of service.

Some aspects described herein relate to an apparatus for wireless communication. The apparatus may include means for transmitting, to a relay UE, an E2E quality of service associated with a link between the apparatus and another apparatus and a route identifier associated with the link between the apparatus and the other apparatus. The apparatus may include means for receiving, from the relay UE, a per-hop quality of service associated with a link between the apparatus and the relay UE. The apparatus may include means for providing the per-hop quality of service.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a UE-to-UE relay connection setup, in accordance with the present disclosure.

FIG. 6 is a diagram illustrating example of quality of service for multi-hop communications, in accordance with the present disclosure.

FIG. 7 is a diagram illustrating an example of UE-to-UE relaying and quality of service splitting, in accordance with the present disclosure.

FIG. 8 is a diagram illustrating an example of quality of service management for Layer 3 UE-to-UE relaying, in accordance with the present disclosure.

FIG. 9 is a diagram illustrating an example of sidelink quality of service management for Layer 2 UE-to-UE relaying, in accordance with the present disclosure.

FIG. 10 is a diagram illustrating an example of radio resource control quality of service management for Layer 2 UE-to-UE relaying, in accordance with the present disclosure.

FIG. 11 is a diagram illustrating an example of sidelink quality of service management for multi-hop Layer 2 UE-to-UE relaying, in accordance with the present disclosure.

FIG. 12 is a diagram illustrating an example of sidelink radio link control channel and sidelink relay adaptation protocol configuration, in accordance with the present disclosure.

FIG. 13 is a diagram illustrating an example of sidelink radio link control channel and sidelink relay adaptation protocol configuration for multi-hop communications, in accordance with the present disclosure.

FIG. 14 is a diagram illustrating an example process performed, for example, by a UE, in accordance with the present disclosure.

FIG. 15 is a diagram illustrating an example process performed, for example, by a UE, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

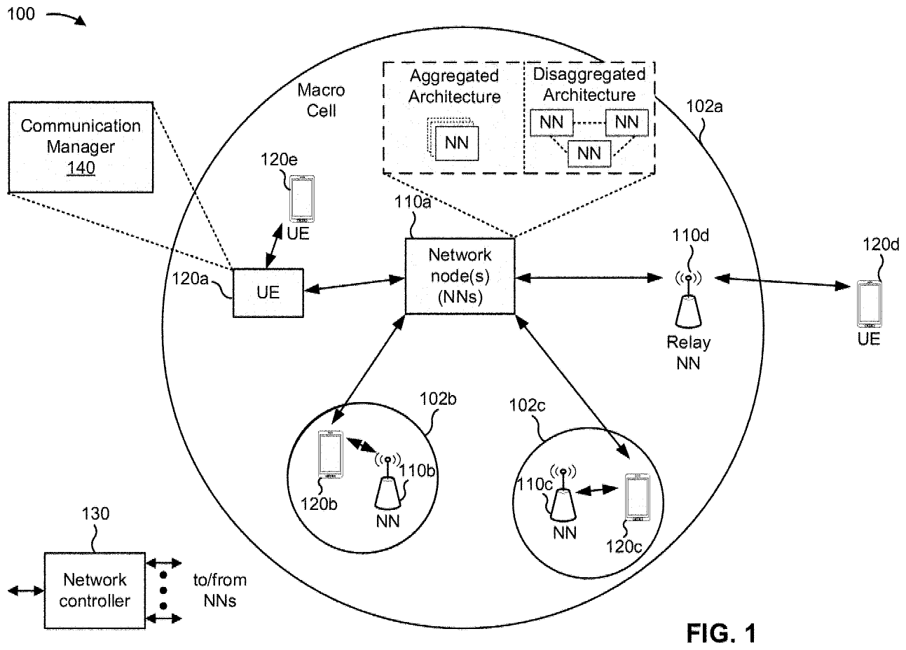

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a relay UE (e.g., a UE 120) may include a communication manager 140. As described in more detail elsewhere herein, the communication manager 140 may receive, from a source UE, an end-to-end (E2E) quality of service associated with a link between the source UE and a destination UE; identify, based at least in part on the E2E quality of service, a first per-hop quality of service to be used for a link between the source UE and the relay UE, and a second per-hop quality of service to be used for one or more other links; and transmit an indication of the first per-hop quality of service or the second per-hop quality of service. Additionally, or alternatively, the communication manager 140 may perform one or more other operations described herein.

In some aspects, a remote UE (e.g., a UE 120) may include a communication manager 140. As described in more detail elsewhere herein, the communication manager 140 may transmit, to a relay UE, an E2E quality of service associated with a link between the remote UE and another remote UE and a route identifier associated with the link between the remote UE and the other remote UE; receive, from the relay UE, a per-hop quality of service associated with a link between the remote UE and the relay UE; and provide the per-hop quality of service. Additionally, or alternatively, the communication manager 140 may perform one or more other operations described herein.

As indicated above, FIG. 1 is provided as an example. Other examples may differ from what is described with regard to FIG. 1.

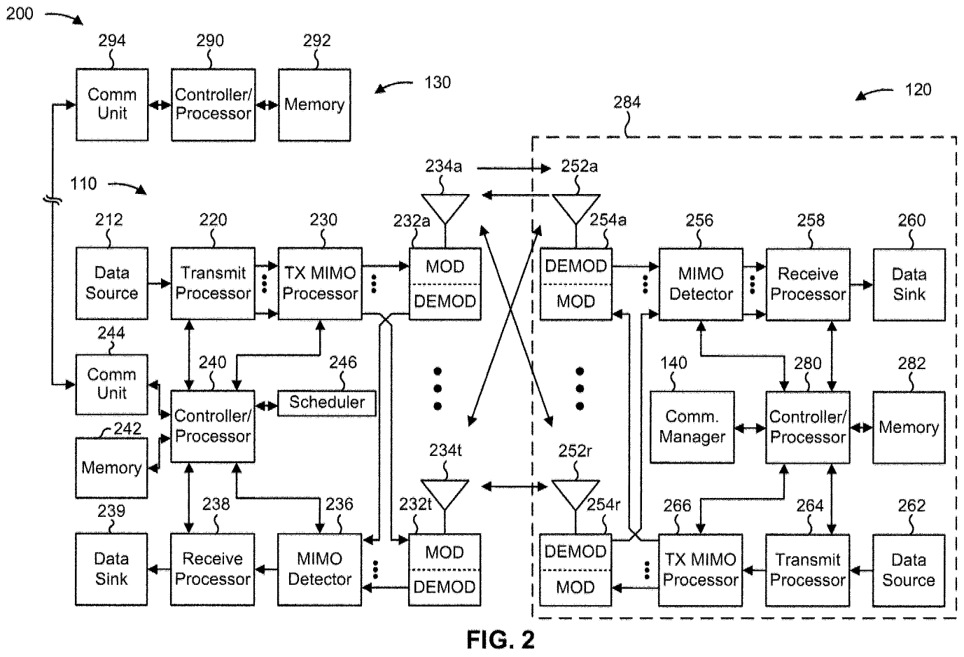

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

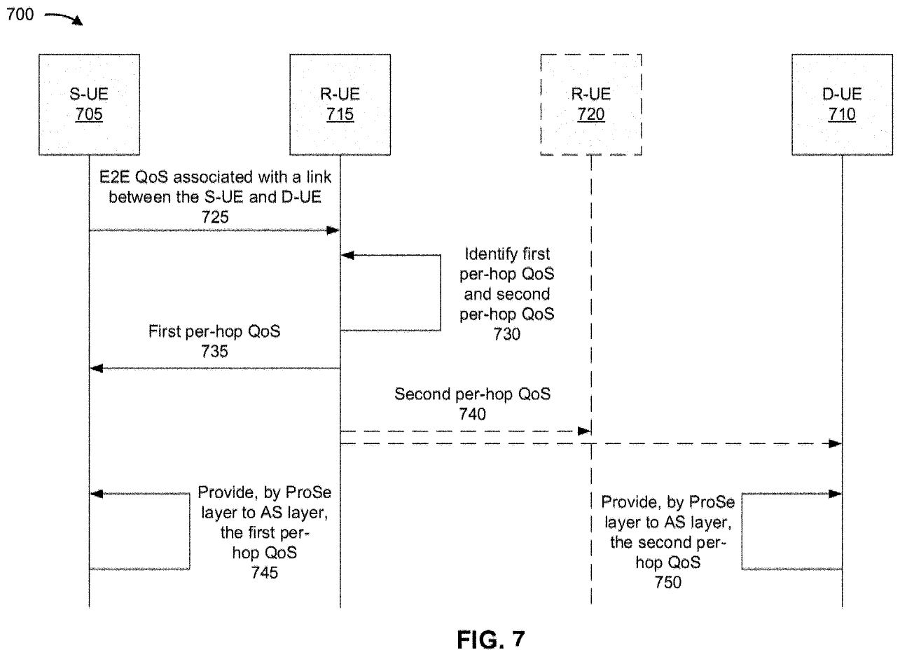

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-16).

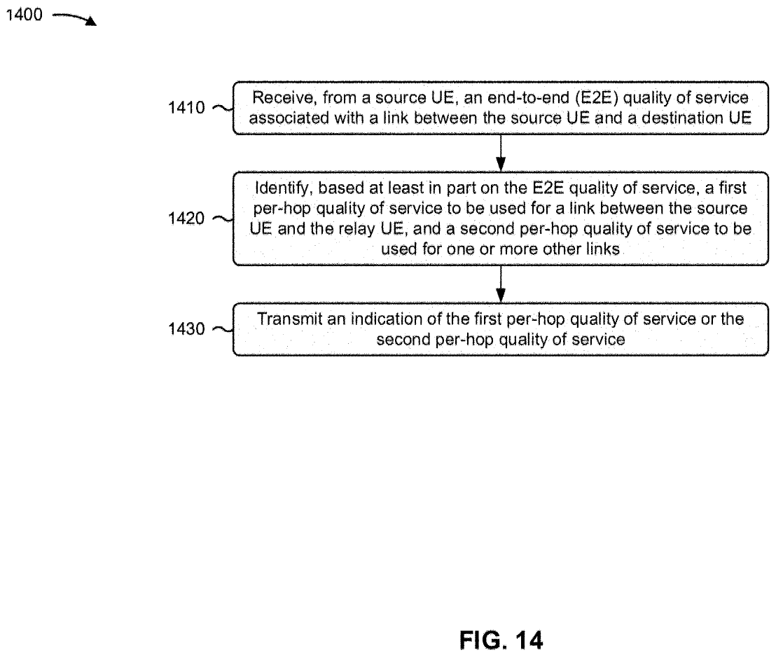

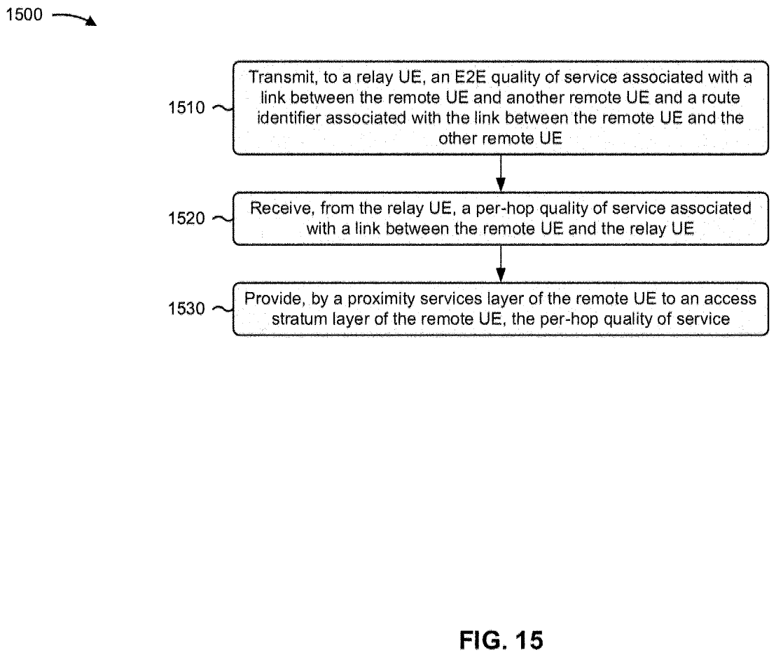

The controller/processor 240 of the network node 110, the controller/processor 280 of the UE 120, and/or any other component(s) of FIG. 2 may perform one or more techniques associated with UE-to-UE relaying and quality of service splitting, as described in more detail elsewhere herein. For example, the controller/processor 240 of the network node 110, the controller/processor 280 of the UE 120, and/or any other component(s) of FIG. 2 may perform or direct operations of, for example, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a relay UE includes means for receiving, from a source UE, an E2E quality of service associated with a link between the source UE and a destination UE; means for identifying, based at least in part on the E2E quality of service, a first per-hop quality of service to be used for a link between the source UE and the relay UE, and a second per-hop quality of service to be used for one or more other links; and/or means for transmitting an indication of the first per-hop quality of service or the second per-hop quality of service. The means for the relay UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a remote UE includes means for transmitting, to a relay UE, an E2E quality of service associated with a link between the remote UE and another remote UE and a route identifier associated with the link between the remote UE and the other remote UE; means for receiving, from the relay UE, a per-hop quality of service associated with a link between the remote UE and the relay UE; and/or means for providing, by a proximity services layer of the remote UE to an access stratum layer of the remote UE, the per-hop quality of service. The means for the remote UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

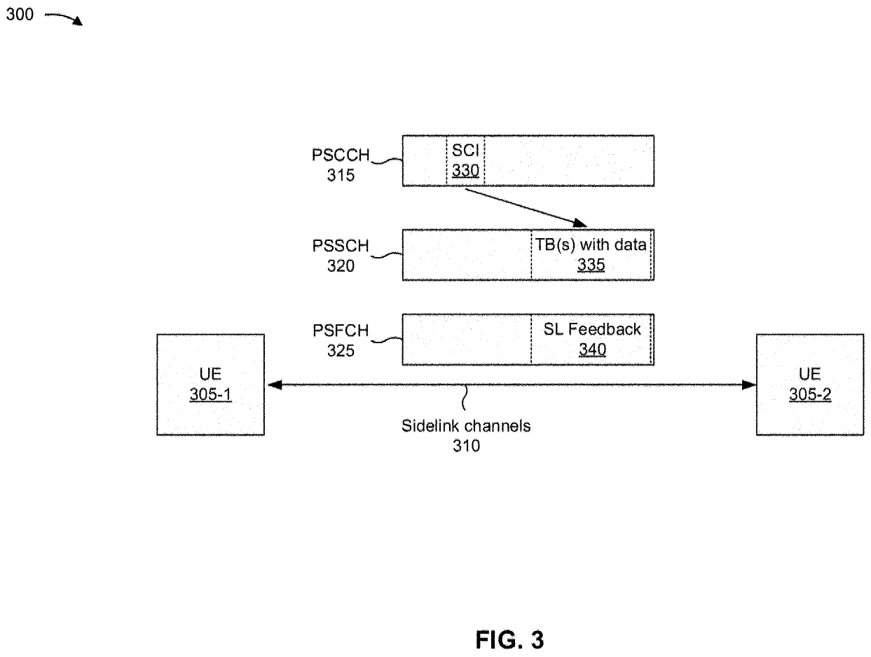

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks across time. In some aspects, data transmissions (e.g., on the PSSCH 320) associated with a scheduling assignment may occupy adjacent resource blocks in the same subframe as the scheduling assignment (e.g., using frequency division multiplexing). In some aspects, a scheduling assignment and associated data transmissions are not transmitted on adjacent resource blocks.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

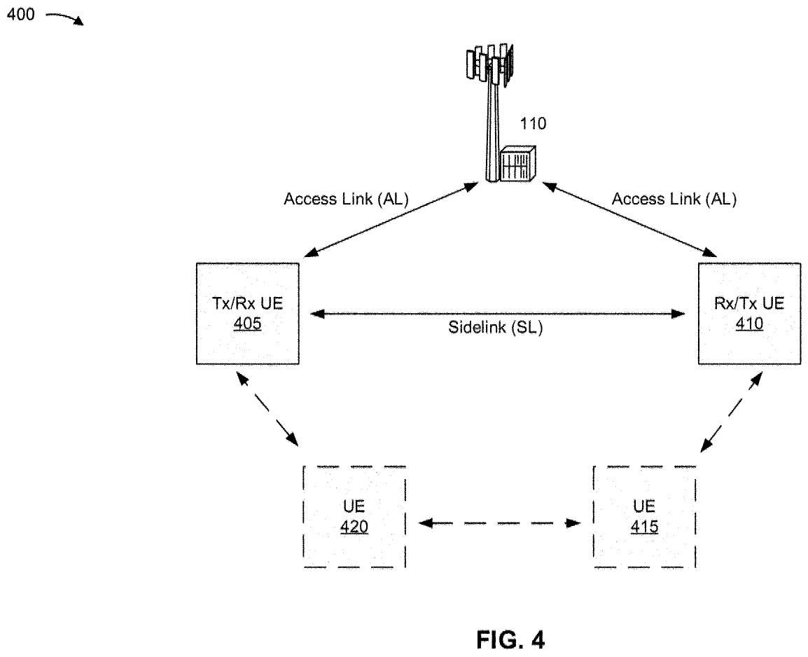

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some cases, at least one of the UE 405 and the UE 410 may be a relay UE. For example, the UE 405 may transmit a communication to the UE 410 via the sidelink interface, and the UE 410 may relay the communication to the network node 110 via the access link interface. This may be referred to as UE-to-network (U2N) relaying. In some cases, the UE 405 or the UE 410 may relay communications between two UEs. For example, the UE 405 may transmit a sidelink communication to the UE 410, and the UE 410 may relay the sidelink communication to another UE, such as the UE 415. This may be referred to as single-hop UE-to-UE (U2U) relaying. In some cases, at least two UEs may be involved in relaying a communication between two other UEs. For example, the UE 405 may transmit a sidelink communication to the UE 410, the UE 410 may relay the sidelink communication to the UE 415, and the UE 415 may relay the sidelink communication to another UE, such as the 420. This may be referred to as multi-hop U2U relaying.

As indicated above, FIG. 4 is provided as an example. Other examples may differ from what is described with respect to FIG. 4.

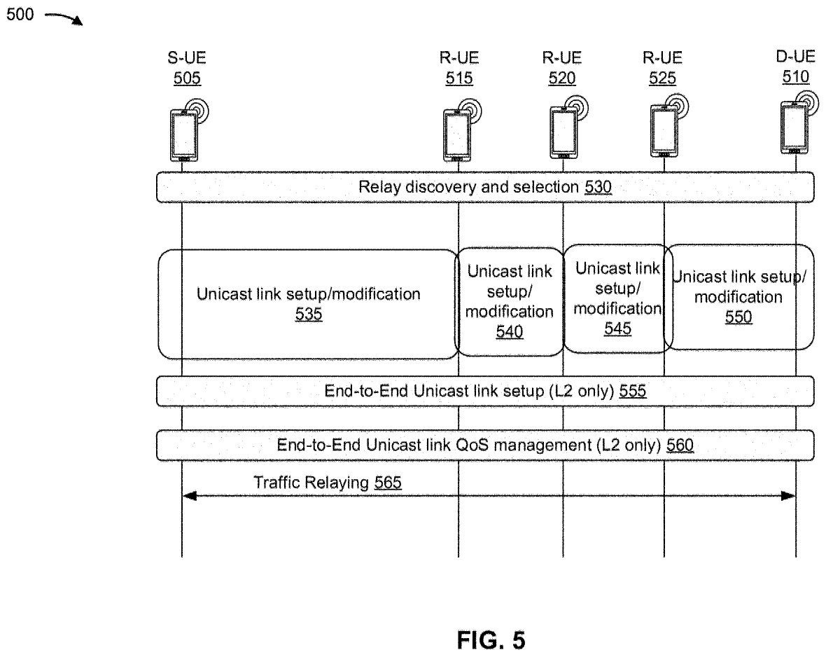

FIG. 5 is a diagram illustrating an example 500 of a UE-to-UE relay connection setup, in accordance with the present disclosure. A source UE (S-UE) 505 may determine to establish a connection with a destination UE (D-UE) 510. The S-UE 505 may determine that the D-UE 510 can be reached via a relay UE (R-UE) or a plurality of R-UEs, such as R-UE 515, R-UE 520, and R-UE 525. As shown by reference number 530, the S-UE 505, the D-UE 510, the R-UE 515, the R-UE 520, and the R-UE 525 may perform a relay discovery and selection procedure to determine that, for a communication to reach the D-UE 510 from the S-UE 505, the communication is to be relayed from the S-UE 505 to the R-UE 515, from the R-UE 515 to the R-UE 520, from the R-UE 520 to the R-UE 525, and from the R-UE 525 to the D-UE 510. The relay discovery and selection procedure may be performed for both Layer 3 (L3) and Layer 2 (L2) communications.

As shown by reference number 535, the S-UE 505 and the R-UE 515 may perform unicast link setup and/or a unicast link modification for a link between the S-UE 505 and the R-UE 515. As shown by reference number 540, the R-UE 515 and the R-UE 520 may perform unicast link setup and/or a unicast link modification for a link between the R-UE 515 and the R-UE 520. As shown by reference number 545, the R-UE 520 and the R-UE 525 may perform unicast link setup and/or a unicast link modification for a link between the R-UE 520 and the R-UE 525. As shown by reference number 550, the R-UE 525 and the D-UE 510 may perform unicast link setup and/or a unicast link modification for a link between the R-UE 525 and the D-UE 510. Each of the unicast link setup and/or unicast link modification procedures may include an indication of the S-UE/D-UE user information.

As shown by reference number 555, an end-to-end (E2E) unicast link setup may be performed for the link(s) between the S-UE 505 and the D-UE 510. The E2E unicast link setup may be performed for L2 communications only. As shown by reference number 560, E2E unicast link QoS management may be performed for the link(s) between the S-UE 505 and the D-UE 510. The E2E unicast link QoS management may be performed for L2 communications only. In some aspects, each UE may be provided with discovery and/or relay security key information. As shown by reference number 565, one or more of the S-UE 505, the R-UE 515, the R-UE 520, the R-UE 525, and the D-UE 510 may perform traffic relaying. For example, a communication may be transmitted from the S-UE 505 to the R-UE 515, from the R-UE 515 to the R-UE 520, from the R-UE 520 to the R-UE 525, and from the R-UE 525 to the D-UE 510.

As indicated above, FIG. 5 is provided as an example. Other examples may differ from what is described with respect to FIG. 5.

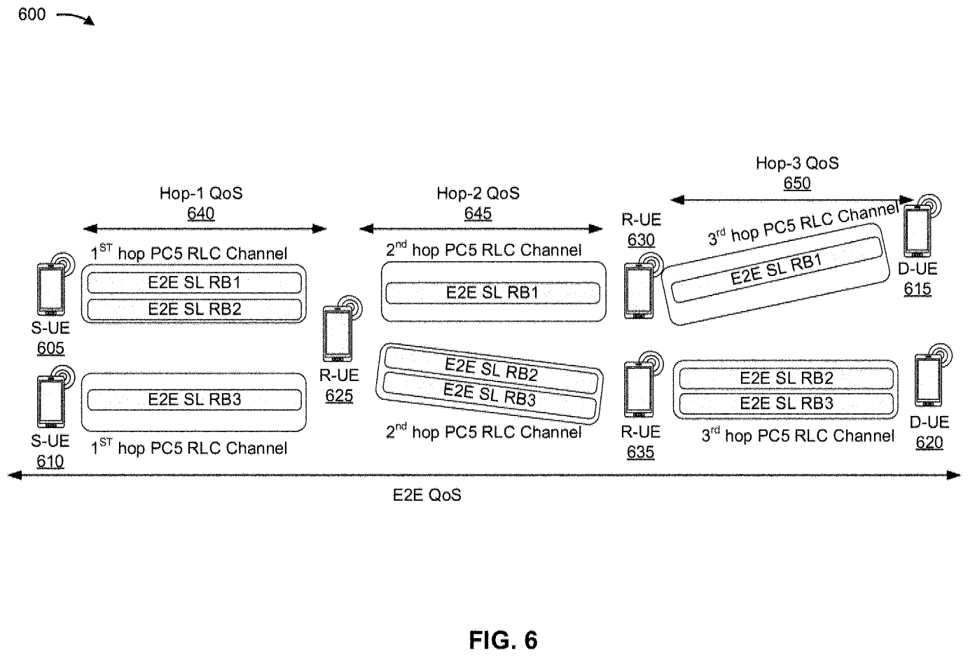

FIG. 6 is a diagram illustrating example 600 of quality of service for multi-hop communications, in accordance with the present disclosure. One or more source UEs, such as S-UE 605 and S-UE 610, may communicate with one or more destination UEs, such as D-UE 615 and D-UE 620. The S-UE 605 may transmit a communication to R-UE 625 via a first E2E SL radio bearer (RB) (E2E SL RB1) and/or via a second E2E SL RB (E2E SL RB2). The S-UE 610 may transmit a communication to R-UE 625 via a third E2E SL RB (E2E SL RB3). The communication from the S-UE 605 to the R-UE 625 and the communication from the S-UE 610 to the R-UE 625 may be associated with a first hop QoS (Hop-1 QoS 640). The R-UE 625 may relay a communication to R-UE 630 via E2E SL RB1. The R-UE 625 may relay a communication to R-UE 635 via E2E SL RB2 and/or via E2E SL RB3. The communications from the R-UE 625 to the R-UE 630 and the communication from the R-UE 625 to the R-UE 635 may be associated with a second hop QoS (Hop-2 QoS 645). The R-UE 630 may relay a communication to the D-UE 615 via the E2E SL RB1. The R-UE 635 may relay a communication to the D-UE 620 via the E2E SL RB2 and/or via the E2E SL RB3. The communication from the R-UE 630 to the D-UE 615 and the communication from the R-UE 635 to the D-UE 620 may be associated with a third hop QoS (Hop-3 QoS 650).

In some cases, a link between an S-UE and a D-UE may be associated with a QoS requirement. For example, the link between the S-UE and the D-UE may need to meet a certain QoS requirement for communications between the S-UE and the D-UE to be successfully transmitted and received. However, when communications are relayed from the S-UE to the D-UE via one or more R-UEs, each UE pair may need to determine a QoS to be used for each hop from the S-UE to the D-UE. Otherwise, the QoS requirements for each hop from the S-UE to the D-UE may not be able to be satisfied, which may result in dropped or disrupted communications.

Techniques and apparatuses are described herein for UE-to-UE relaying and QoS splitting. In some aspects, a relay UE may receive, from a source UE, an E2E QoS associated with a link between the source UE and a destination UE. The relay UE may identify a first per-hop QoS to be used for a link between the source UE and the relay UE, and a second per-hop QoS to be used for one or more other links, based at least in part on the E2E QoS. For example, the relay UE may split an E2E QoS amount into a first per-hop QoS amount to be used for the link between the source UE and the relay UE and a second per-hop QoS amount to be used for the one or more other links. The relay UE may transmit an indication of the first per-hop QoS or the second per-hop QoS. In some aspects, a remote UE, such as a source UE or a destination UE, may transmit, to a relay UE, an E2E QoS associated with a link between the remote UE and another remote UE and a route identifier associated with the link between the remote UE and the other remote UE. The remote UE may receive, from the relay UE, a per-hop QoS associated with a link between the remote UE and the relay UE. A proximity services layer of the remote UE may provide, to an access stratum layer of the remote UE, an indication of the per-hop QoS. This may enable each UE pair associated with each hop from the source UE to the destination UE to ensure that QoS requirements are satisfied. Additional details are described herein.

As indicated above, FIG. 6 is provided as an example. Other examples may differ from what is described with respect to FIG. 6.

FIG. 7 is a diagram illustrating an example 700 of UE-to-UE relaying and QoS splitting, in accordance with the present disclosure. An S-UE 705 may communicate with a D-UE 710 via one or more R-UEs, such as R-UE 715 and/or R-UE 720. For example, the S-UE 705 may determine that, for a communication to reach the D-UE 710, the communication needs to be relayed from the S-UE 705 to the R-UE 715, from the R-UE 715 to the R-UE 720, and from the R-UE 720 to the D-UE 710. Alternatively, the S-UE 705 may determine that, for a communication to reach the D-UE 710, the communication needs to be relayed from the S-UE 705 to the R-UE 715, and from the R-UE 715 to the D-UE 710.

As shown by reference number 725, the S-UE 705 (or another remote UE, such as the D-UE 710) may transmit, and the R-UE 715 may receive, an E2E QoS associated with a link between the S-UE 705 and the D-UE 710.

As shown by reference number 730, the R-UE 715 may identify, based at least in part on the E2E QoS, a first per-hop QoS to be used for a link between the S-UE 705 and the R-UE 715, and a second per-hop QoS to be used for one or more other links. In one example, such as in a multi-hop relay scenario, the one or more other links may include the link between the R-UE 715 and the R-UE 720, and the link between the R-UE 720 and the D-UE 710. In another example, such as in a single-hop relay scenario, the one or more other links may include the link between the R-UE 715 and the D-UE 710.

In some aspects, identifying the first per-hop QoS and the second per-hop QoS may include splitting an E2E QoS amount into a first per-hop QoS amount to be used for the link between the S-UE 705 and the R-UE 715 and a second per-hop QoS amount to be used for the one or more other links. In some aspects, splitting the E2E QoS amount into the first per-hop QoS amount and the second per-hop QoS amount may include splitting an E2E packet delay budget (PDB) of 100 milliseconds (ms) into a first per-hop PDB (e.g., 40 ms) and a second per-hop PDB (e.g., 60 ms).

In some aspects, identifying the first per-hop QoS and the second per-hop QoS may include identifying the first per-hop QoS and the second per-hop QoS based at least in part on a link quality, a load condition of a next-hop UE, and/or a number of hops. In some aspects, identifying the first per-hop QoS and the second per-hop QoS may include identifying the first per-hop QoS and the second per-hop QoS based at least in part on a processing delay requirement and/or a load condition associated with the R-UE 715.

As shown by reference numbers 735 and 740, the R-UE 715 may transmit an indication of the first per-hop QoS and/or the second per-hop QoS. For example, as shown by reference number 735, the R-UE 715 may transmit an indication of the first per-hop QoS to the S-UE 705. Additionally, or alternatively, as shown by reference number 740, the R-UE 715 may transmit an indication of the second per-hop QoS to the R-UE 720 (in the multi-hop scenario) or to the D-UE 710 (in the single-hop scenario). In some aspects, transmitting the indication of the first per-hop QoS may include transmitting the indication of the first per-hop QoS to the S-UE 705 via a unicast link between the S-UE 705 and the R-UE 715, and transmitting the indication of the second per-hop QoS may include transmitting the indication of the second per-hop QoS to the R-UE 715 via a unicast link between the S-UE 705 and the R-UE 715, or to the D-UE 710 via a unicast link between the R-UE 715 and the D-UE 710.

In some aspects, receiving the sidelink signaling message over a per-hop unicast link may include receiving a PC5-S link modification request message, where the PC5-S link modification request message includes E2E QoS flow information associated with the E2E QoS and at least one of a route identifier or user information associated with the S-UE 705 and the D-UE 710. In some aspects, transmitting the indication of the first per-hop QoS or the second per-hop QoS includes transmitting, to the S-UE 705, a PC5-S link modification response message that includes the E2E QoS flow information and the indication of the first per-hop QoS. In some aspects, transmitting the indication of the first per-hop QoS or the second per-hop QoS comprises transmitting, to another R-UE (such as the R-UE 720) or the D-UE 710, another PC5-S link modification request message that includes the E2E QoS flow information and the indication of the second per-hop QoS.

In some aspects, receiving the E2E QoS associated with the link between the S-UE 705 and the D-UE 710 may include receiving a sidelink RRC reconfiguration message, where the sidelink RRC reconfiguration message includes E2E QoS flow information associated with the E2E QoS and at least one of a route identifier or user information associated with the S-UE 705 and the D-UE 710. In some aspects, transmitting the indication of the first per-hop QoS or the second per-hop QoS includes transmitting, to the S-UE 705, a sidelink RRC reconfiguration complete message that includes the E2E QoS flow information and the indication of the first per-hop QoS. In some aspects, transmitting the indication of the first per-hop QoS or the second per-hop QoS includes transmitting, to another R-UE (such as the R-UE 720) or the D-UE 710, another sidelink RRC reconfiguration message that includes the E2E QoS flow information and the indication of the second per-hop QoS.

As shown by reference number 745, a proximity services (ProSe) layer of the S-UE 705 may provide the first per-hop QoS to an access stratum (AS) layer of the S-UE 705. Additionally, or alternatively, as shown by reference number 750, a ProSe layer of the D-UE 710 may provide the first per-hop QoS to an AS layer of the D-UE 710.

In some aspects, the AS layer of the remote UE (e.g., the S-UE 705 and/or the D-UE 710) may determine radio link control (RLC) or MAC configuration information based at least in part on the per-hop QoS received by the ProSe of the remote UE. In some aspects, the AS layer of the remote UE may determine a PC5 RLC channel configuration that includes the RLC or MAC configuration information. In some aspects, the AS layer of the remote UE may determine a sidelink relay adaptation protocol (SRAP) configuration that includes the route identifier or a sidelink radio bearer to PC5 radio link control channel identifier mapping.

In some aspects, the remote UE may transmit, to the R-UE 715, sidelink data adaptation protocol information for assisting with QoS flow identification by the R-UE 715. In some aspects, the remote UE may transmit, to the R-UE 715, PC5 radio link control channel configuration information and sidelink relay adaptation protocol configuration information. In some aspects, the remote UE may transmit, to the R-UE 715, a sidelink radio resource control reconfiguration message that includes a route identifier, E2E radio bearer information, PC5 radio link control channel configuration information, and sidelink relay adaptation protocol configuration information, where the E2E radio bearer information includes a radio bearer identifier and sidelink data adaptation protocol configuration information. Additional details are described herein.

As indicated above, FIG. 7 is provided as an example. Other examples may differ from what is described with respect to FIG. 7.

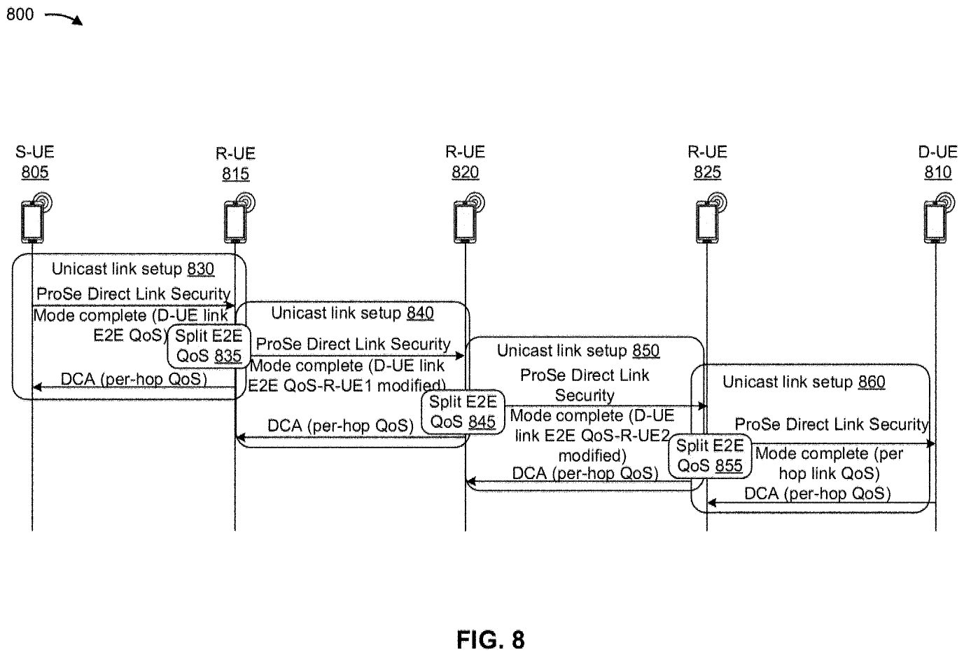

FIG. 8 is a diagram illustrating an example 800 of quality of service management for Layer 3 UE-to-UE relaying, in accordance with the present disclosure. An S-UE 805 may communicate with a D-UE 810 via one or more R-UEs, such as R-UE 815, R-UE 820, and R-UE 825.

As shown by reference number 830, the S-UE 805 and the R-UE 815 may perform a unicast link setup. The S-UE 805 may transmit, and the R-UE 815 may receive, a ProSe layer direct link security mode complete message. The ProSe layer direct link security mode complete message may indicate an E2E QoS for a link between the S-UE 805 and the D-UE 810. For example, the ProSe layer direct link security mode complete message may indicate a PDB of 100 ms for the E2E link between the S-UE 805 and the D-UE 810.

As shown by reference number 835, the R-UE 815 may perform QoS splitting. The R-UE 815 may split the E2E QoS into a first QoS to be used for the link between the S-UE 805 and the R-UE 815 and a second QoS to be used for one or more other communication links (such as the link between the R-UE 815 and the R-UE 820, the link between the R-UE 820 and the R-UE 825, and the link between the R-UE 825 and the D-UE 810). For example, the R-UE 815 may determine that 20 ms of the PDB is to be used for the link between the S-UE 805 and the R-UE 815 and 80 ms of the PDB is to be used for the one or more other communication links. The R-UE 815 may transmit, and the S-UE 805 may receive, a dynamic channel allocation (DCA) message that includes an indication of the first QoS.

As shown by reference number 840, the R-UE 815 and the R-UE 820 may perform a unicast link setup. The R-UE 815 may transmit, and the R-UE 820 may receive, a ProSe layer direct link security mode complete message. The ProSe layer direct link security mode complete message may include an indication of the second QoS to be used by the one or more other communication links between the R-UE 815 and the D-UE 810. In one example, the ProSe layer direct link security mode complete message may indicate that a PDB of 80 ms is to be used for the communication links between the R-UE 815 and the D-UE 810.

As shown by reference number 845, the R-UE 820 may perform QoS splitting. The R-UE 820 may split the second QoS into a third QoS to be used for the link between the R-UE 815 and the R-UE 820 and a fourth QoS to be used for one or more other communication links (such as the link between the R-UE 820 and the R-UE 825, and the link between the R-UE 825 and the D-UE 810). For example, the R-UE 820 may determine that 10 ms of the PDB is to be used for the link between the R-UE 815 and the R-UE 820 and 70 ms of the PDB is to be used for the one or more other communication links. The R-UE 820 may transmit, and the R-UE 815 may receive, a DCA message that includes an indication of the third QoS.

As shown by reference number 850, the R-UE 820 and the R-UE 825 may perform a unicast link setup. The R-UE 820 may transmit, and the R-UE 825 may receive, a ProSe layer direct link security mode complete message. The ProSe layer direct link security mode complete message may include an indication of the fourth QoS to be used by the one or more communication links between the R-UE 820 and the D-UE 810. In one example, the ProSe layer direct link security mode complete message may indicate that a PDB of 70 ms is to be used for the communication links between the R-UE 820 and the D-UE 810.

As shown by reference number 855, the R-UE 825 may perform QoS splitting. The R-UE 825 may split the fourth QoS into a fifth QoS to be used for the link between the R-UE 820 and the R-UE 825 and a sixth QoS to be used for one or more other communication links (such as the link between the R-UE 825 and the D-UE 810). For example, the R-UE 825 may determine that 30 ms of the PDB is to be used for the link between the R-UE 820 and the R-UE 825 and 40 ms of the PDB is to be used for the one or more other communication links. The R-UE 825 may transmit, and the R-UE 820 may receive, a DCA message that includes an indication of the fifth QoS.

As shown by reference number 860, the R-UE 825 and the D-UE 810 may perform a unicast link setup. The R-UE 825 may transmit, and the D-UE 810 may receive, a ProSe layer direct link security mode complete message. The ProSe layer direct link security mode complete message may include an indication of the sixth QoS to be used by the link between the R-UE 825 and the D-UE 810. In one example, the ProSe layer direct link security mode complete message may indicate that a PDB of 40 ms is to be used for the communication link between the R-UE 825 and the D-UE 810. The D-UE 810 may transmit, and the R-UE 825 may receive, a DCA message that confirms the per-hop QoS.

As indicated above, FIG. 8 is provided as an example. Other examples may differ from what is described with respect to FIG. 8.

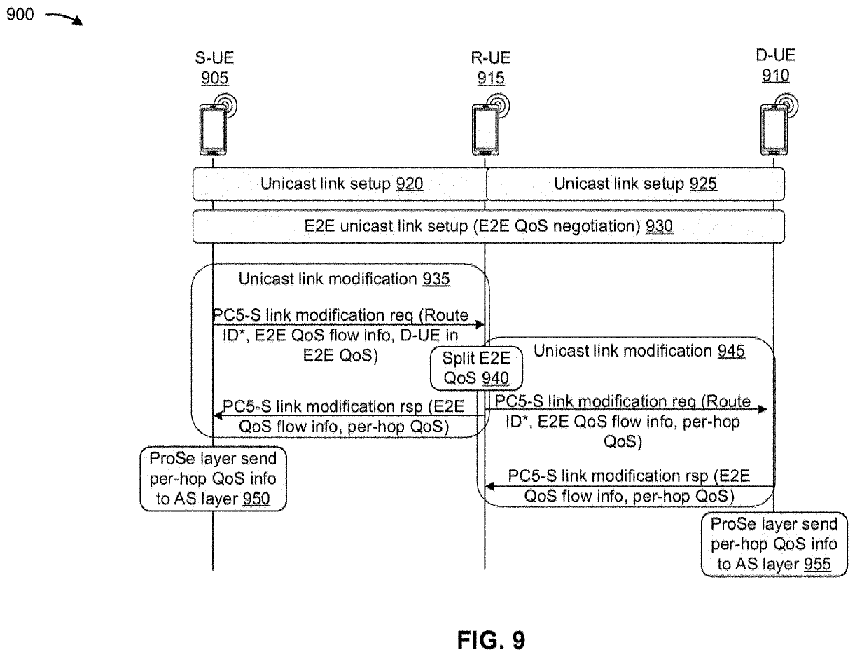

FIG. 9 is a diagram illustrating an example 900 of sidelink quality of service management for Layer 2 UE-to-UE relaying, in accordance with the present disclosure. An S-UE 905 may communicate with a D-UE 910 via an R-UE 915. The S-UE 905 may determine that, for a communication to reach the D-UE 910, the communication is to be relayed via the R-UE 915. As shown by reference number 920, the S-UE 905 and the R-UE 915 may perform a unicast link setup. This may enable the S-UE 905 and the R-UE 915 to communicate directly using a unicast link. As shown by reference number 925, the R-UE 915 and the D-UE 910 may perform a unicast link setup. This may enable the R-UE 915 and the D-UE 910 to communicate directly using a unicast link. As shown by reference number 930, an E2E unicast link setup may be performed for an E2E link between the S-UE 905 and the D-UE 910. The E2E unicast link setup may include an E2E QoS negotiation, for example, to determine an E2E QoS to be used for the link between the S-UE 905 and the D-UE 910.

As shown by reference number 935, the S-UE 905 may transmit, and the R-UE 915 may receive, a unicast link modification message. The unicast link modification message may be, or may include, a sidelink PC5 (PC5-S) link modification request message. The PC5-S link modification request message may include a route identifier (ID), E2E QoS flow information, and an E2E QoS indication. The E2E QoS indication may include an indication of the E2E QoS to be used for the link between the S-UE 905 and the D-UE 910. In some aspects, the PC5-S link modification request message may include S-UE/D-UE user information instead of, or in addition to, the route ID.

As shown by reference number 940, the R-UE 915 may perform QoS splitting. For example, the R-UE 915 may split the E2E QoS into a first QoS to be used for the link between the S-UE 905 and the R-UE 915 and a second QoS to be used for one or more other links, such as a link between the R-UE 915 and the D-UE 910. The R-UE 915 may transmit, and the S-UE 905 may receive, a PC5-S link modification response message that includes the E2E QoS flow information and that indicates a per-hop QoS (e.g., the first QoS).

As shown by reference number 945, the R-UE 915 may transmit, and the D-UE 910 may receive, a unicast link modification message. The unicast link modification message may be, or may include, a PC5-S link modification request message. The PC5-S link modification request message may include the route ID, E2E QoS flow information, and a per-hop QoS (e.g., the second QoS). In some aspects, the PC5-S link modification request message may include S-UE/D-UE user information instead of, or in addition to, the route ID. The D-UE 910 may transmit, and the R-UE 915 may receive, a PC5-S link modification response message that includes the E2E QoS flow information and that indicates a per-hop QoS (e.g., the second QoS).

As shown by reference number 950, a ProSe layer of the S-UE 905 may provide the per-hop QoS information (e.g., the first QoS) to an AS layer of the S-UE 905. As shown by reference number 955, a ProSe layer of the D-UE 910 may provide the per-hop QoS information (e.g., the second QoS) to an AS layer of the D-UE 910.

As indicated above, FIG. 9 is provided as an example. Other examples may differ from what is described with respect to FIG. 9.

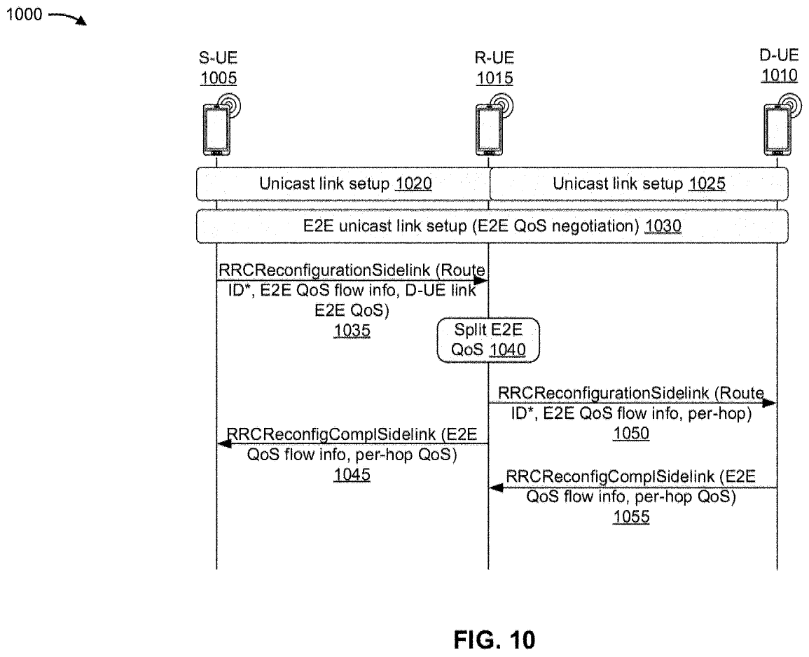

FIG. 10 is a diagram illustrating an example 1000 of radio resource control quality of service management for Layer 2 UE-to-UE relaying, in accordance with the present disclosure. An S-UE 1005 may communicate with a D-UE 1010 via an R-UE 1015. The S-UE 1005 may determine that, for a communication to reach the D-UE 1010, the communication is to be relayed via the R-UE 1015. As shown by reference number 1020, the S-UE 1005 and the R-UE 1015 may perform a unicast link setup. This may enable the S-UE 1005 and the R-UE 1015 to communicate directly using a unicast link. As shown by reference number 1025, the R-UE 1015 and the D-UE 1010 may perform a unicast link setup. This may enable the R-UE 1015 and the D-UE 1010 to communicate directly using a unicast link. As shown by reference number 1030, an E2E unicast link setup may be performed for an E2E link between the S-UE 1005 and the D-UE 1010. The E2E unicast link setup may include an E2E QoS negotiation, for example, to determine an E2E QoS to be used for the link between the S-UE 1005 and the D-UE 1010.

As shown by reference number 1035, the S-UE 1005 may transmit, and the R-UE 1015 may receive, a sidelink RRC reconfiguration message (e.g., RRCReconfigurationSidelink). The sidelink RRC reconfiguration message may include a route ID, E2E QoS flow information, and an E2E QoS indication. The E2E QoS indication may include an indication of the E2E QoS to be used for the link between the S-UE 1005 and the D-UE 1010. In some aspects, the sidelink RRC reconfiguration message may include S-UE/D-UE user information instead of, or in addition to, the route ID.

As shown by reference number 1040, the R-UE 1015 may perform QoS splitting. For example, the R-UE 1015 may split the E2E QoS into a first QoS to be used for the link between the S-UE 1005 and the R-UE 1015 and a second QoS to be used for one or more other links, such as a link between the R-UE 1015 and the D-UE 1010. As shown by reference number 1045, the R-UE 1015 may transmit, and the S-UE 1005 may receive, a sidelink RRC reconfiguration complete message (e.g., RRCReconfigurationComplSidelink) that includes the E2E QoS flow information and that indicates a per-hop QoS (e.g., the first QoS).

As shown by reference number 1050, the R-UE 1015 may transmit, and the D-UE 1010 may receive, a sidelink RRC reconfiguration message. The sidelink RRC reconfiguration message may include the route ID, E2E QoS flow information, and a per-hop QoS (e.g., the second QoS). In some aspects, the sidelink RRC reconfiguration message may include S-UE/D-UE user information instead of, or in addition to, the route ID. As shown by reference number 1055, the D-UE 1010 may transmit, and the R-UE 1015 may receive, a sidelink RRC reconfiguration complete message that includes the E2E QoS flow information and that indicates the per-hop QoS (e.g., the second QoS).

As indicated above, FIG. 10 is provided as an example. Other examples may differ from what is described with respect to FIG. 10.

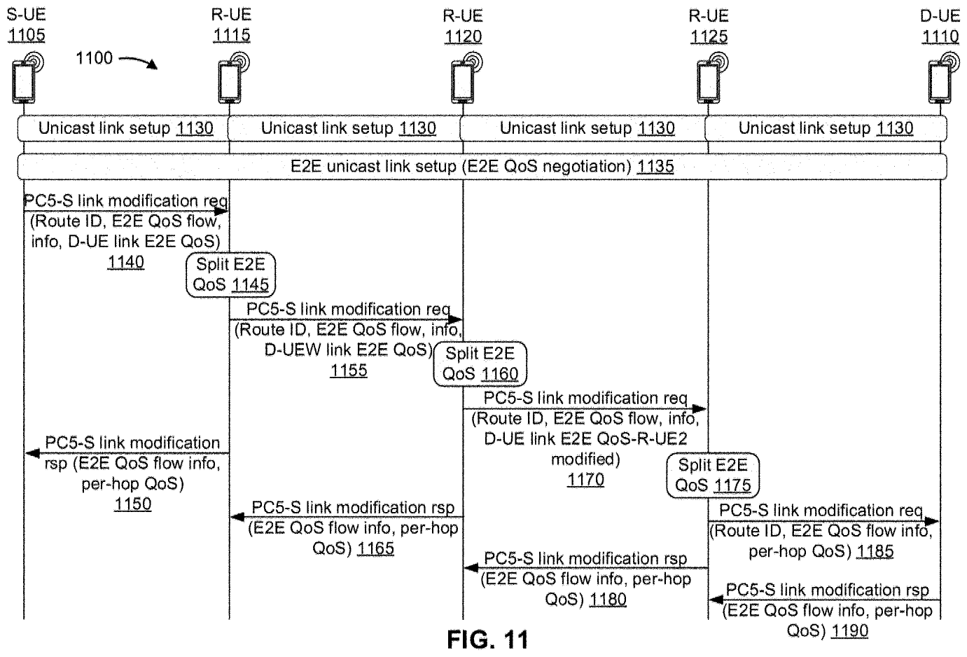

FIG. 11 is a diagram illustrating an example 1100 of sidelink quality of service management for multi-hop Layer 2 UE-to-UE relaying, in accordance with the present disclosure. An S-UE 1105 may communicate with a D-UE 1110 via one or more R-UEs, such as R-UE 1115, R-UE 1120, and R-UE 1125. As shown by reference number 1130, the S-UE 1105, R-UE 1115, R-UE 1120, R-UE 1125, and/or D-UE 1110 may perform unicast link setups. For example, the S-UE 1105 and the R-UE 1115 may perform a unicast link setup to establish a unicast link between the S-UE 1105 and the R-UE 1115, the R-UE 1115 and the R-UE 1120 may perform a unicast link setup to establish a unicast link between the R-UE 1115 and the R-UE 1120, the R-UE 1120 and the R-UE 1125 may perform a unicast link setup to establish a unicast link between the R-UE 1120 and the R-UE 1125, and the R-UE 1125 and the D-UE 1110 may perform a unicast link setup to establish a unicast link between the R-UE 1125 and the D-UE 1110. As shown by reference number 1135, an E2E unicast link setup may be performed for an E2E link between the S-UE 1105 and the D-UE 1110. The E2E unicast link setup may include an E2E QoS negotiation, for example, to determine an E2E QoS to be used for the link between the S-UE 1105 and the D-UE 1110.

As shown by reference number 1140, the S-UE 1105 may transmit, and the R-UE 1115 may receive, a unicast link modification message. The unicast link modification message may be, or may include, a PC5-S link modification request message. The PC5-S link modification request message may include a route ID, E2E QoS flow information, and an E2E QoS indication. The E2E QoS indication may include an indication of the E2E QoS to be used for the link between the S-UE 1105 and the D-UE 1110. In some aspects, the PC5-S link modification request message may include S-UE/D-UE user information instead of, or in addition to, the route ID.

As shown by reference number 1145, the R-UE 1115 may perform QoS splitting. For example, the R-UE 1115 may split the E2E QoS into a first QoS to be used for the link between the S-UE 1005 and the R-UE 1015 and a second QoS to be used for one or more other links, such as the link between the R-UE 1115 and the R-UE 1120, the link between the R-UE 1120 and the R-UE 1125, and the link between the R-UE 1125 and the D-UE 1110.

As shown by reference number 1150, the R-UE 1115 may transmit, and the S-UE 1105 may receive, a PC5-S link modification response message that includes the E2E QoS flow information and that indicates a per-hop QoS (e.g., the first QoS).

As shown by reference number 1155, the R-UE 1115 may transmit, and the R-UE 1120 may receive, a PC5-S link modification request message. The PC5-S link modification request message may include the route ID, E2E QoS flow information, and an E2E QoS indication. The E2E QoS indication may include an indication of the second QoS.

As shown by reference number 1160, the R-UE 1120 may perform QoS splitting. For example, the R-UE 1120 may split the second QoS into a third QoS to be used for the link between the R-UE 1115 and the R-UE 1120 and a fourth QoS to be used for one or more other links, such as the link between the R-UE 1120 and the R-UE 1125, and the link between the R-UE 1125 and the D-UE 1110.

As shown by reference number 1165, the R-UE 1120 may transmit, and the R-UE 1115 may receive, a PC5-S link modification response message that includes the E2E QoS flow information and that indicates a per-hop QoS (e.g., the third QoS).

As shown by reference number 1170, the R-UE 1120 may transmit, and the R-UE 1125 may receive, a PC5-S link modification request message. The PC5-S link modification request message may include the route ID, E2E QoS flow information, and an E2E QoS indication. The E2E QoS indication may include an indication of the fourth QoS.

As shown by reference number 1175, the R-UE 1125 may perform QoS splitting. For example, the R-UE 1125 may split the fourth QoS into a fifth QoS to be used for the link between the R-UE 1120 and the R-UE 1125 and a sixth QoS to be used for one or more other links, such as the link between the R-UE 1125 and the D-UE 1110.

As shown by reference number 1180, the R-UE 1125 may transmit, and the R-UE 1115 may receive, a PC5-S link modification response message that includes the E2E QoS flow information and that indicates a per-hop QoS (e.g., the fifth QoS).

As shown by reference number 1185, the R-UE 1125 may transmit, and the D-UE 1110 may receive, a PC5-S link modification request message. The PC5-S link modification request message may include the route ID, E2E QoS flow information, and an E2E QoS indication. The E2E QoS indication may include an indication of the sixth QoS.

As shown by reference number 1190, the D-UE 1110 may transmit, and the R-UE 1125 may receive, a PC5-S link modification response message that includes the E2E QoS flow information and that indicates a per-hop QoS (e.g., the sixth QoS).

As indicated above, FIG. 11 is provided as an example. Other examples may differ from what is described with respect to FIG. 11.

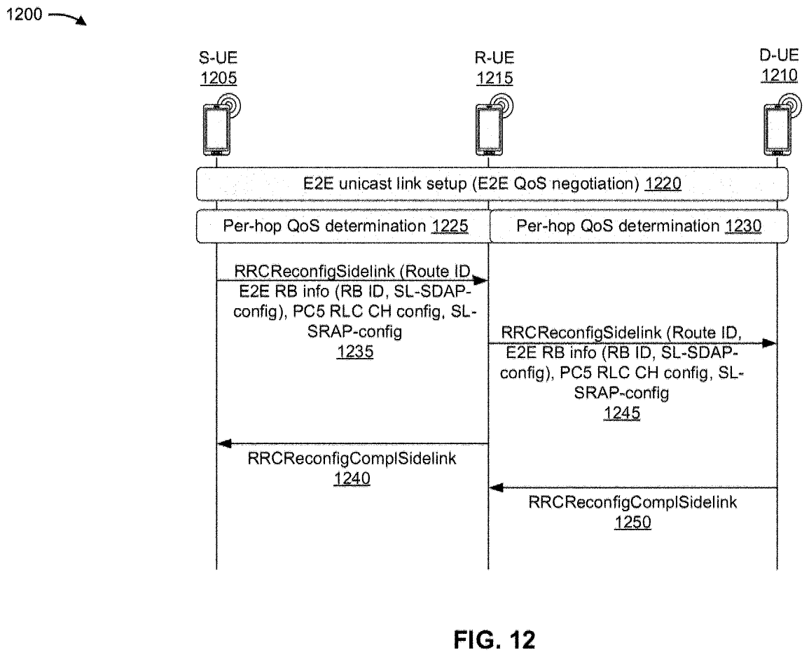

FIG. 12 is a diagram illustrating an example 1200 of sidelink radio link control channel and sidelink relay adaptation protocol configuration, in accordance with the present disclosure. An S-UE 1205 may communicate with a D-UE 1210 via an R-UE 1215.

In some aspects, an AS layer may determine the RLC and/or MAC configurations corresponding to the per-hop split QoS received from a QoS layer. In some aspects, a PC5 RLC channel configuration may include RLC configuration and/or MAC logical channel configuration. In some aspects, a remote UE (such as the S-UE or the D-UE) SRAP layer configuration may include a route ID and/or a sidelink radio bearer to PC5 RLC channel identifier mapping. In some aspects, the R-UE SRAP configuration may include the route ID and/or an ingress PC5 RLC channel to egress PC5 RLC channel identifier mapping.

As shown by reference number 1220, an E2E unicast link setup may be performed for a link between the S-UE 1205 and the D-UE 1210. As described herein, the E2E unicast link setup may include an E2E QoS negotiation to determine a QoS for communications between the S-UE 1205 and the D-UE 1210. As shown by reference number 1225, the S-UE 1205 and the R-UE 1215 may determine a per-hop QoS to be used for communications between the S-UE 1205 and the R-UE 1215. As shown by reference number 1230, the R-UE 1215 and the D-UE 1210 may determine a per-hop QoS to be used for communications between the R-UE 1215 and the D-UE 1210. The QoS to be used for the communications between the S-UE 1205 and the R-UE 1215, and the QoS to be used for communications between the R-UE 1215 and the D-UE 1210, may be based at least in part on a QoS splitting of the E2E QoS, as described herein.

As shown by reference number 1235, the S-UE 1205 may transmit, and the R-UE 1215 may receive, a sidelink RRC reconfiguration message (e.g., RRCReconfigSidelink). The sidelink RRC reconfiguration message may include a route ID, E2E radio bearer information, PC5 RLC channel configuration information, and SRAP configuration information. The E2E radio bearer information may include a radio bearer identifier and/or sidelink service data adaptation protocol (SDAP) configuration information. As shown by reference number 1240, the R-UE 1215 may transmit, and the S-UE 1205 may receive, a sidelink RRC reconfiguration complete message (e.g., RRCReconfigComplSidelink).

As shown by reference number 1245, the R-UE 1215 may transmit, and the D-UE 1210 may receive, a sidelink RRC reconfiguration message. The sidelink RRC reconfiguration message may include the route ID, E2E radio bearer information, PC5 RLC channel configuration information, and SRAP configuration information. The E2E radio bearer information may include a radio bearer identifier and/or SDAP configuration information. As shown by reference number 1250, the D-UE 1210 may transmit, and the R-UE 1215 may receive, a sidelink RRC reconfiguration complete message.

In some aspects, a transmitter UE may configure the PC5 RLC channel and SRAP configuration, which may be forward-compatible for multi-hop communications. The transmitter UE may be, for example, the UE that initiates the unicast link setup. In some aspects, sidelink SDAP configuration information may be sent to an R-UE to assist the R-UE with QoS flow identification. The transmitter UE (e.g., the S-UE or the R-UE) may transmit the PC5 RLC channel configuration information and SRAP configuration information to the receiver UE. In some aspects, the R-UE may maintain the ingress to egress PC5 RLC channel mapping for each direction. A split PDB may be known to the R-UE from the E2E QoS information. Thus, there may be no need to indicate the split PDB explicitly.

As indicated above, FIG. 12 is provided as an example. Other examples may differ from what is described with respect to FIG. 12.

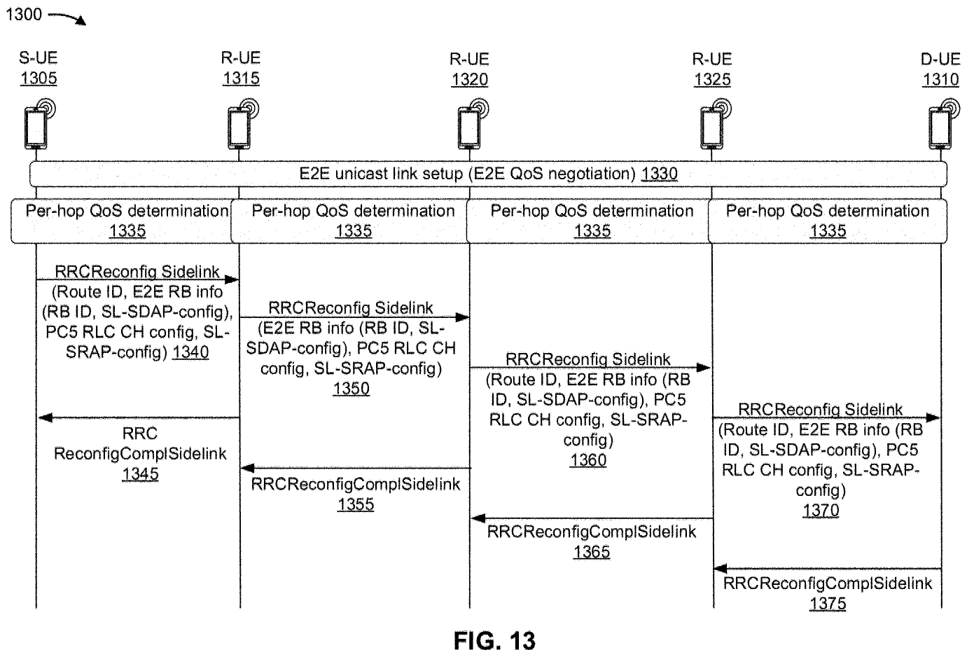

FIG. 13 is a diagram illustrating an example 1300 of sidelink radio link control channel and sidelink relay adaptation protocol configuration for multi-hop communications, in accordance with the present disclosure. An S-UE 1305 may communicate with a D-UE 1310 via one or more R-UEs, such as R-UE 1315, R-UE 1320, and R-UE 1325.

As shown by reference number 1330, an E2E unicast link setup may be performed for a link between the S-UE 1305 and the D-UE 1310. As described herein, the E2E unicast link setup may include an E2E QoS negotiation to determine a QoS for communications between the S-UE 1305 and the D-UE 1310.

As shown by reference number 1335, the S-UE 1305, R-UE 1315, R-UE 1320, R-UE 1325, and/or D-UE 1310 may perform per-hop QoS determination procedures. In one example, the R-UE 1315 may determine a per-hop QoS to be used for a link between the R-UE 1315 and the S-UE 1305, the R-UE 1320 may determine a per-hop QoS to be used for a link between the R-UE 1320 and the R-UE 1315, and the R-UE 1325 may determine a per-hop QoS to be used for a link between the R-UE 1325 and the R-UE 1320 and for a link between the R-UE 1325 and the D-UE 1310.

As shown by reference number 1340, the S-UE 1305 may transmit, and the R-UE 1315 may receive, a sidelink RRC reconfiguration message (e.g., RRCReconfigSidelink). The sidelink RRC reconfiguration message may include a route ID, E2E radio bearer information, PC5 RLC channel configuration information, and SRAP configuration information. The E2E radio bearer information may include a radio bearer identifier and/or SDAP configuration information. As shown by reference number 1345, the R-UE 1315 may transmit, and the S-UE 1305 may receive, a sidelink RRC reconfiguration complete message (e.g., RRCReconfigComplSidelink).

As shown by reference number 1350, the R-UE 1315 may transmit, and the R-UE 1320 may receive, a sidelink RRC reconfiguration message. The sidelink RRC reconfiguration message may include the route ID, the E2E radio bearer information, the PC5 RLC channel configuration information, and the SRAP configuration information. The E2E radio bearer information may include the radio bearer identifier and/or the SDAP configuration information. As shown by reference number 1355, the R-UE 1320 may transmit, and the R-UE 1315 may receive, a sidelink RRC reconfiguration complete message.

As shown by reference number 1360, the R-UE 1320 may transmit, and the R-UE 1315 may receive, a sidelink RRC reconfiguration message. The sidelink RRC reconfiguration message may include the route ID, the E2E radio bearer information, the PC5 RLC channel configuration information, and the SRAP configuration information. The E2E radio bearer information may include the radio bearer identifier and/or the SDAP configuration information. As shown by reference number 1365, the R-UE 1325 may transmit, and the R-UE 1320 may receive, a sidelink RRC reconfiguration complete message.

As shown by reference number 1370, the R-UE 1325 may transmit, and the D-UE 1310 may receive, a sidelink RRC reconfiguration message. The sidelink RRC reconfiguration message may include the route ID, the E2E radio bearer information, the PC5 RLC channel configuration information, and the SRAP configuration information. The E2E radio bearer information may include the radio bearer identifier and/or the SDAP configuration information. As shown by reference number 1375, the D-UE 1310 may transmit, and the R-UE 1325 may receive, a sidelink RRC reconfiguration complete message.

As indicated above, FIG. 13 is provided as an example. Other examples may differ from what is described with respect to FIG. 13.

FIG. 14 is a diagram illustrating an example process 1400 performed, for example, by a UE (e.g., a relay UE), in accordance with the present disclosure. Example process 1400 is an example where the UE (e.g., UE 120) performs operations associated with UE-to-UE relaying and quality of service management.

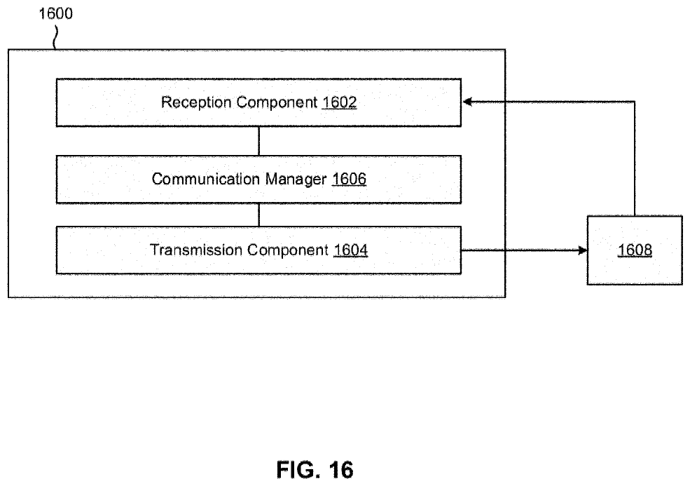

As shown in FIG. 14, in some aspects, process 1400 may include receiving, from a source UE, an E2E quality of service associated with a link between the source UE and a destination UE (block 1410). For example, the UE (e.g., using reception component 1602 and/or communication manager 1606, depicted in FIG. 16) may receive, from a source UE, an E2E quality of service associated with a link between the source UE and a destination UE, as described above.

As further shown in FIG. 14, in some aspects, process 1400 may include identifying, based at least in part on the E2E quality of service, a first per-hop quality of service to be used for a link between the source UE and the relay UE, and a second per-hop quality of service to be used for one or more other links (block 1420). For example, the UE (e.g., using communication manager 1606, depicted in FIG. 16) may identify, based at least in part on the E2E quality of service, a first per-hop quality of service to be used for a link between the source UE and the relay UE, and a second per-hop quality of service to be used for one or more other links, as described above.

As further shown in FIG. 14, in some aspects, process 1400 may include transmitting an indication of the first per-hop quality of service or the second per-hop quality of service (block 1430). For example, the UE (e.g., using transmission component 1604 and/or communication manager 1606, depicted in FIG. 16) may transmit an indication of the first per-hop quality of service or the second per-hop quality of service, as described above.

Process 1400 may include additional aspects, such as any single aspect or any combination of aspects described below and/or in connection with one or more other processes described elsewhere herein.

In a first aspect, identifying the first per-hop quality of service and the second per-hop quality of service comprises splitting an E2E quality of service amount into a first per-hop quality of service amount to be used for the link between the source UE and the relay UE and a second per-hop quality of service amount to be used for the one or more other links.

In a second aspect, alone or in combination with the first aspect, a next-hop UE is the destination UE, and identifying the second per-hop quality of service comprises identifying a second per-hop quality of service to be used for a link, of the one or more other links, between the relay UE and the destination UE.

In a third aspect, alone or in combination with one or more of the first and second aspects, a next-hop UE is another relay UE, and identifying the second per-hop quality of service comprises identifying a second per-hop quality of service to be used at least for a link, of the one or more other links, between the relay UE and the other relay UE, and for a link, of the one or more other links, between the other relay UE and the destination UE.

In a fourth aspect, alone or in combination with one or more of the first through third aspects, receiving the E2E quality of service comprises receiving a sidelink signaling message over a per-hop unicast link that includes an indication of the E2E quality of service, and transmitting the indication of the first per-hop quality of service or the second per-hop quality of service comprises transmitting another sidelink signaling message over a per-hop unicast link that includes the indication of the first per-hop quality of service or the second per-hop quality of service.

In a fifth aspect, alone or in combination with one or more of the first through fourth aspects, process 1400 includes configuring a per-hop flow PC5 quality of service parameter to meet an E2E quality of service requirement during a per-hop unicast link setup or a per-hop unicast link modification.

In a sixth aspect, alone or in combination with one or more of the first through fifth aspects, identifying the first per-hop quality of service and the second per-hop quality of service comprises identifying the first per-hop quality of service and the second per-hop quality of service based at least in part on a link quality, a load condition of a next-hop UE, and a number of hops.

In a seventh aspect, alone or in combination with one or more of the first through sixth aspects, identifying the first per-hop quality of service or the second per-hop quality of service comprises determining a packet delay budget split for each hop.

In an eighth aspect, alone or in combination with one or more of the first through seventh aspects, identifying the first per-hop quality of service and the second per-hop quality of service comprises identifying the first per-hop quality of service and the second per-hop quality of service based at least in part on a processing delay requirement, or a load condition associated with the relay UE.

In a ninth aspect, alone or in combination with one or more of the first through eighth aspects, process 1400 includes providing, by a proximity services layer of the relay UE to an access stratum layer of the relay UE, an indication of the first per-hop quality of service.

In a tenth aspect, alone or in combination with one or more of the first through ninth aspects, process 1400 includes configuring, by an access stratum layer of the relay UE, one or more sidelink radio bearers, based at least in part on the first per-hop quality of service.

In an eleventh aspect, alone or in combination with one or more of the first through tenth aspects, receiving the E2E quality of service comprises receiving a sidelink signaling message over a per-hop unicast link that includes an indication of the E2E quality of service, and transmitting the indication of the first per-hop quality of service or the second per-hop quality of service comprises transmitting another sidelink signaling message over a per-hop unicast link that includes the indication of the first per-hop quality of service or the second per-hop quality of service.

In a twelfth aspect, alone or in combination with one or more of the first through eleventh aspects, receiving the sidelink signaling message over a per-hop unicast link comprises receiving a PC5-S link modification request message, wherein the PC5-S link modification request message includes E2E quality of service flow information associated with the E2E quality of service and at least one of a route identifier or user information associated with the source UE and the destination UE.

In a thirteenth aspect, alone or in combination with one or more of the first through twelfth aspects, transmitting the indication of the first per-hop quality of service or the second per-hop quality of service comprises transmitting, to the source UE, a PC5-S link modification response message that includes the E2E quality of service flow information and the indication of the first per-hop quality of service.

In a fourteenth aspect, alone or in combination with one or more of the first through thirteenth aspects, transmitting the indication of the first per-hop quality of service or the second per-hop quality of service comprises transmitting, to another relay UE or the destination UE, another PC5-S link modification request message that includes the E2E quality of service flow information and the indication of the second per-hop quality of service.

In a fifteenth aspect, alone or in combination with one or more of the first through fourteenth aspects, receiving the E2E quality of service associated with the link between the source UE and the destination UE comprises receiving a sidelink radio resource control (RRC) reconfiguration message, wherein the sidelink RRC reconfiguration message includes E2E quality of service flow information associated with the E2E quality of service and at least one of a route identifier or user information associated with the source UE and the destination UE.

In a sixteenth aspect, alone or in combination with one or more of the first through fifteenth aspects, transmitting the indication of the first per-hop quality of service or the second per-hop quality of service comprises transmitting, to the source UE, a sidelink RRC reconfiguration complete message that includes the E2E quality of service flow information and the indication of the first per-hop quality of service.

In a seventeenth aspect, alone or in combination with one or more of the first through sixteenth aspects, transmitting the indication of the first per-hop quality of service or the second per-hop quality of service comprises transmitting, to another relay UE or the destination UE, another sidelink RRC reconfiguration message that includes the E2E quality of service flow information and the indication of the second per-hop quality of service.

In an eighteenth aspect, alone or in combination with one or more of the first through seventeenth aspects, a proximity services layer associated with the relay UE sends an indication of the first per-hop quality of service to an access stratum layer of the relay UE.

In a nineteenth aspect, alone or in combination with one or more of the first through eighteenth aspects, process 1400 includes determining, by the access stratum layer of the relay UE, radio link control or medium access control configuration information based at least in part on the first per-hop quality of service received by the proximity services layer of the relay UE.

In a twentieth aspect, alone or in combination with one or more of the first through nineteenth aspects, process 1400 includes determining a PC5 radio link control channel configuration that includes the radio link control or medium access control configuration information.

In a twenty-first aspect, alone or in combination with one or more of the first through twentieth aspects, process 1400 includes configuring, by a sidelink relay adaptation protocol layer of the relay UE, a route identifier or an ingress PC5 radio link control channel to egress PC5 radio link control channel identifier mapping.

In a twenty-second aspect, alone or in combination with one or more of the first through twenty-first aspects, process 1400 includes maintaining the ingress PC5 radio link control channel to egress PC5 radio link control channel identifier mapping for at least one of the link between the source UE and the relay UE or a link between the relay UE and the destination UE.

In a twenty-third aspect, alone or in combination with one or more of the first through twenty-second aspects, process 1400 includes receiving, from the source UE, sidelink service data adaptation protocol information for assisting with quality of service flow identification by the relay UE.

In a twenty-fourth aspect, alone or in combination with one or more of the first through twenty-third aspects, process 1400 includes receiving, from the source UE, PC5 radio link control channel configuration information and sidelink relay adaptation protocol configuration information.

In a twenty-fifth aspect, alone or in combination with one or more of the first through twenty-fourth aspects, process 1400 includes receiving, from the source UE, a sidelink RRC reconfiguration message that includes a route identifier, E2E radio bearer information, PC5 radio link control (RLC) channel configuration information, and sidelink relay adaptation protocol (SRAP) configuration information, wherein the E2E radio bearer information includes a radio bearer identifier and sidelink service data adaptation protocol configuration information.

In a twenty-sixth aspect, alone or in combination with one or more of the first through twenty-fifth aspects, process 1400 includes transmitting, to another relay UE or the destination UE, another sidelink RRC reconfiguration message that includes the route identifier, the E2E radio bearer information, the PC5 RLC channel configuration information, and the SRAP configuration information.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a UE (e.g., a remote UE), in accordance with the present disclosure. Example process 1500 is an example where the UE (e.g., UE 120) performs operations associated with UE-to-UE relaying and quality of service management.

As shown in FIG. 15, in some aspects, process 1500 may include transmitting, to a relay UE, an E2E quality of service associated with a link between the remote UE and another remote UE and a route identifier associated with the link between the remote UE and the other remote UE (block 1510). For example, the UE (e.g., using transmission component 1604 and/or communication manager 1606, depicted in FIG. 16) may transmit, to a relay UE, an E2E quality of service associated with a link between the remote UE and another remote UE and a route identifier associated with the link between the remote UE and the other remote UE, as described above.

As further shown in FIG. 15, in some aspects, process 1500 may include receiving, from the relay UE, a per-hop quality of service associated with a link between the remote UE and the relay UE (block 1520). For example, the UE (e.g., using reception component 1602 and/or communication manager 1606, depicted in FIG. 16) may receive, from the relay UE, a per-hop quality of service associated with a link between the remote UE and the relay UE, as described above.

As further shown in FIG. 15, in some aspects, process 1500 may include providing the per-hop quality of service (block 1530). For example, the UE (e.g., using communication manager 1606, depicted in FIG. 16) may provide the per-hop quality of service, as described above.

Process 1500 may include additional aspects, such as any single aspect or any combination of aspects described below and/or in connection with one or more other processes described elsewhere herein.

In a first aspect, the remote UE is a source UE and the other remote UE is a destination UE.

In a second aspect, alone or in combination with the first aspect, process 1500 includes determining the E2E quality of service and the route identifier based at least in part on a proximity services layer discovery process.

In a third aspect, alone or in combination with one or more of the first and second aspects, transmitting the E2E quality of service comprises transmitting a Layer 3 (L3) communication that includes an indication of the E2E quality of service, and receiving the per-hop quality of service comprises receiving another L3 communication that includes an indication of the per-hop quality of service.

In a fourth aspect, alone or in combination with one or more of the first through third aspects, process 1500 includes configuring, by an access stratum layer of the remote UE, one or more sidelink radio bearers based at least in part on the per-hop quality of service.

In a fifth aspect, alone or in combination with one or more of the first through fourth aspects, transmitting the E2E quality of service comprises transmitting a Layer 2 (L2) communication that includes an indication of the E2E quality of service, and receiving the per-hop quality of service comprises receiving another L2 communication that includes an indication of the per-hop quality of service.

In a sixth aspect, alone or in combination with one or more of the first through fifth aspects, transmitting the E2E quality of service comprises transmitting a PC5-S link modification request message, wherein the PC5-S link modification request message includes E2E quality of service flow information associated with the E2E quality of service and the route identifier.

In a seventh aspect, alone or in combination with one or more of the first through sixth aspects, receiving the per-hop quality of service comprises receiving, from the relay UE, a PC5-S link modification response message that includes the E2E quality of service flow information and an indication of the per-hop quality of service.

In an eighth aspect, alone or in combination with one or more of the first through seventh aspects, transmitting the E2E quality of service comprises transmitting a sidelink RRC reconfiguration message, wherein the sidelink RRC reconfiguration message includes E2E quality of service flow information associated with the E2E quality of service and the route identifier.

In a ninth aspect, alone or in combination with one or more of the first through eighth aspects, receiving the per-hop quality of service comprises receiving, from the relay UE, a sidelink RRC reconfiguration complete message that includes the E2E quality of service flow information and the indication of the per-hop quality of service.

In a tenth aspect, alone or in combination with one or more of the first through ninth aspects, process 1500 includes determining, by the access stratum layer of the remote UE, radio link control or medium access control configuration information based at least in part on the per-hop quality of service received by the proximity services layer of the remote UE.

In an eleventh aspect, alone or in combination with one or more of the first through tenth aspects, process 1500 includes determining a PC5 radio link control channel configuration that includes the radio link control or medium access control configuration information.

In a twelfth aspect, alone or in combination with one or more of the first through eleventh aspects, process 1500 includes determining a sidelink relay adaptation protocol configuration that includes the route identifier or a sidelink radio bearer to PC5 radio link control channel identifier mapping.

In a thirteenth aspect, alone or in combination with one or more of the first through twelfth aspects, process 1500 includes transmitting, to the relay UE, sidelink data adaptation protocol information for assisting with quality of service flow identification by the relay UE.

In a fourteenth aspect, alone or in combination with one or more of the first through thirteenth aspects, process 1500 includes transmitting, to the relay UE, PC5 radio link control channel configuration information and sidelink relay adaptation protocol configuration information.

In a fifteenth aspect, alone or in combination with one or more of the first through fourteenth aspects, process 1500 includes transmitting, to the relay UE, a sidelink radio resource control reconfiguration message that includes a route identifier, E2E radio bearer information, PC5 radio link control channel configuration information, and sidelink relay adaptation protocol configuration information, wherein the E2E radio bearer information includes a radio bearer identifier and sidelink data adaptation protocol configuration information.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604. In some aspects, the UE may be a relay UE (such as the R-UE 715). In some aspects, the UE may be a remote UE (such as the S-UE 705 or the D-UE 710).

In some aspects, the apparatus 1600 may be configured to perform one or more operations described herein in connection with FIGS. 7-13. Additionally, or alternatively, the apparatus 1600 may be configured to perform one or more processes described herein, such as process 1400 of FIG. 14, process 1500 of FIG. 15, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive, from a source UE, an E2E quality of service associated with a link between the source UE and a destination UE. The communication manager 1606 may identify, based at least in part on the E2E quality of service, a first per-hop quality of service to be used for a link between the source UE and the relay UE, and a second per-hop quality of service to be used for one or more other links. The transmission component 1604 may transmit an indication of the first per-hop quality of service or the second per-hop quality of service.

The communication manager 1606 may configure a per-hop flow PC5 quality of service parameter to meet an E2E quality of service requirement during a per-hop unicast link setup or a per-hop unicast link modification. The communication manager 1606 may provide an indication of the first per-hop quality of service. The communication manager 1606 may configure one or more sidelink radio bearers, based at least in part on the first per-hop quality of service. The communication manager 1606 may determine radio link control or medium access control configuration information based at least in part on the first per-hop quality of service received by the proximity services layer of the relay UE. The communication manager 1606 may determine a PC5 radio link control channel configuration that includes the radio link control or medium access control configuration information. The communication manager 1606 may configure a route identifier or an ingress PC5 radio link control channel to egress PC5 radio link control channel identifier mapping. The communication manager 1606 may maintain the ingress PC5 radio link control channel to egress PC5 radio link control channel identifier mapping for at least one of the link between the source UE and the relay UE or a link between the relay UE and the destination UE. The reception component 1602 may receive, from the source UE, sidelink service data adaptation protocol information for assisting with quality of service flow identification by the relay UE. The reception component 1602 may receive, from the source UE, PC5 radio link control channel configuration information and sidelink relay adaptation protocol configuration information. The reception component 1602 may receive, from the source UE, a sidelink RRC reconfiguration message that includes a route identifier, E2E radio bearer information, PC5 RLC channel configuration information, and SRAP configuration information, wherein the E2E radio bearer information includes a radio bearer identifier and sidelink service data adaptation protocol configuration information.

The transmission component 1604 may transmit, to another relay UE or the destination UE, another sidelink RRC reconfiguration message that includes the route identifier, the E2E radio bearer information, the PC5 RLC channel configuration information, and the SRAP configuration information.

The transmission component 1604 may transmit, to a relay UE, an E2E quality of service associated with a link between the remote UE and another remote UE and a route identifier associated with the link between the remote UE and the other remote UE. The reception component 1602 may receive, from the relay UE, a per-hop quality of service associated with a link between the remote UE and the relay UE. The communication manager 1606 may provide the per-hop quality of service.

The communication manager 1606 may determine the E2E quality of service and the route identifier based at least in part on a proximity services layer discovery process. The communication manager 1606 may configure one or more sidelink radio bearers based at least in part on the per-hop quality of service. The communication manager 1606 may determine radio link control or medium access control configuration information based at least in part on the per-hop quality of service received by the proximity services layer of the remote UE. The communication manager 1606 may determine a PC5 radio link control channel configuration that includes the radio link control or medium access control configuration information. The communication manager 1606 may determine a sidelink relay adaptation protocol configuration that includes the route identifier or a sidelink radio bearer to PC5 radio link control channel identifier mapping. The transmission component 1604 may transmit, to the relay UE, sidelink data adaptation protocol information for assisting with quality of service flow identification by the relay UE. The transmission component 1604 may transmit, to the relay UE, PC5 radio link control channel configuration information and sidelink relay adaptation protocol configuration information. The transmission component 1604 may transmit, to the relay UE, a sidelink radio resource control reconfiguration message that includes a route identifier, E2E radio bearer information, PC5 radio link control channel configuration information, and sidelink relay adaptation protocol configuration information, wherein the E2E radio bearer information includes a radio bearer identifier and sidelink data adaptation protocol configuration information.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by a relay user equipment (UE), comprising: receiving, from a source UE, an end-to-end (E2E) quality of service associated with a link between the source UE and a destination UE; identifying, based at least in part on the E2E quality of service, a first per-hop quality of service to be used for a link between the source UE and the relay UE, and a second per-hop quality of service to be used for one or more other links; and transmitting an indication of the first per-hop quality of service or the second per-hop quality of service.
Aspect 2: The method of Aspect 1, wherein identifying the first per-hop quality of service and the second per-hop quality of service comprises splitting an E2E quality of service amount into a first per-hop quality of service amount to be used for the link between the source UE and the relay UE and a second per-hop quality of service amount to be used for the one or more other links.
Aspect 3: The method of any of Aspects 1-2, wherein a next-hop UE is the destination UE, and wherein identifying the second per-hop quality of service comprises identifying a second per-hop quality of service to be used for a link, of the one or more other links, between the relay UE and the destination UE.
Aspect 4: The method of any of Aspects 1-3, wherein a next-hop UE is another relay UE, and wherein identifying the second per-hop quality of service comprises identifying a second per-hop quality of service to be used at least for a link, of the one or more other links, between the relay UE and the other relay UE, and for a link, of the one or more other links, between the other relay UE and the destination UE.
Aspect 5: The method of any of Aspects 1-4, wherein receiving the E2E quality of service comprises receiving a sidelink signaling message over a per-hop unicast link that includes an indication of the E2E quality of service, and wherein transmitting the indication of the first per-hop quality of service or the second per-hop quality of service comprises transmitting another sidelink signaling message over a per-hop unicast link that includes the indication of the first per-hop quality of service or the second per-hop quality of service.
Aspect 6: The method of Aspect 5, further comprising configuring a per-hop flow PC5 quality of service parameter to meet an E2E quality of service requirement during a per-hop unicast link setup or a per-hop unicast link modification.
Aspect 7: The method of Aspect 5, wherein identifying the first per-hop quality of service and the second per-hop quality of service comprises identifying the first per-hop quality of service and the second per-hop quality of service based at least in part on a link quality, a load condition of a next-hop UE, and a number of hops.
Aspect 8: The method of Aspect 5, wherein identifying the first per-hop quality of service or the second per-hop quality of service comprises determining a packet delay budget split for each hop.
Aspect 9: The method of Aspect 5, wherein identifying the first per-hop quality of service and the second per-hop quality of service comprises identifying the first per-hop quality of service and the second per-hop quality of service based at least in part on a processing delay requirement, or a load condition associated with the relay UE.
Aspect 10: The method of Aspect 5, further comprising providing, by a proximity services layer of the relay UE to an access stratum layer of the relay UE, an indication of the first per-hop quality of service.
Aspect 11: The method of Aspect 10, further comprising configuring, by the access stratum layer of the relay UE, one or more sidelink radio bearers, based at least in part on the first per-hop quality of service.
Aspect 12: The method of any of Aspects 1-11, wherein receiving the E2E quality of service comprises receiving a sidelink signaling message over a per-hop unicast link that includes an indication of the E2E quality of service, and wherein transmitting the indication of the first per-hop quality of service or the second per-hop quality of service comprises transmitting another sidelink signaling message over a per-hop unicast link that includes the indication of the first per-hop quality of service or the second per-hop quality of service.
Aspect 13: The method of Aspect 12, wherein receiving the sidelink signaling message over a per-hop unicast link comprises receiving a sidelink PC5 (PC5-S) link modification request message, wherein the PC5-S link modification request message includes E2E quality of service flow information associated with the E2E quality of service and at least one of a route identifier or user information associated with the source UE and the destination UE.
Aspect 14: The method of Aspect 13, wherein transmitting the indication of the first per-hop quality of service or the second per-hop quality of service comprises transmitting, to the source UE, a PC5-S link modification response message that includes the E2E quality of service flow information and the indication of the first per-hop quality of service.
Aspect 15: The method of Aspect 13, wherein transmitting the indication of the first per-hop quality of service or the second per-hop quality of service comprises transmitting, to another relay UE or the destination UE, another PC5-S link modification request message that includes the E2E quality of service flow information and the indication of the second per-hop quality of service.
Aspect 16: The method of Aspect 12, wherein receiving the E2E quality of service associated with the link between the source UE and the destination UE comprises receiving a sidelink radio resource control (RRC) reconfiguration message, wherein the sidelink RRC reconfiguration message includes E2E quality of service flow information associated with the E2E quality of service and at least one of a route identifier or user information associated with the source UE and the destination UE.
Aspect 17: The method of Aspect 16, wherein transmitting the indication of the first per-hop quality of service or the second per-hop quality of service comprises transmitting, to the source UE, a sidelink RRC reconfiguration complete message that includes the E2E quality of service flow information and the indication of the first per-hop quality of service.
Aspect 18: The method of Aspect 16, wherein transmitting the indication of the first per-hop quality of service or the second per-hop quality of service comprises transmitting, to another relay UE or the destination UE, another sidelink RRC reconfiguration message that includes the E2E quality of service flow information and the indication of the second per-hop quality of service.
Aspect 19: The method of any of Aspects 1-18, wherein a proximity services layer associated with the relay UE sends an indication of the first per-hop quality of service to an access stratum layer of the relay UE.
Aspect 20: The method of Aspect 19, further comprising determining, by the access stratum layer of the relay UE, radio link control or medium access control configuration information based at least in part on the first per-hop quality of service received by the proximity services layer of the relay UE.
Aspect 21: The method of Aspect 20, further comprising determining a PC5 radio link control channel configuration that includes the radio link control or medium access control configuration information.
Aspect 22: The method of any of Aspects 1-21, further comprising configuring, by a sidelink relay adaptation protocol layer of the relay UE, a route identifier or an ingress PC5 radio link control channel to egress PC5 radio link control channel identifier mapping.
Aspect 23: The method of Aspect 22, further comprising maintaining the ingress PC5 radio link control channel to egress PC5 radio link control channel identifier mapping for at least one of the link between the source UE and the relay UE or a link between the relay UE and the destination UE.
Aspect 24: The method of any of Aspects 1-23, further comprising receiving, from the source UE, sidelink service data adaptation protocol information for assisting with quality of service flow identification by the relay UE.
Aspect 25: The method of any of Aspects 1-24, further comprising receiving, from the source UE, PC5 radio link control channel configuration information and sidelink relay adaptation protocol configuration information.
Aspect 26: The method of any of Aspects 1-25, further comprising receiving, from the source UE, a sidelink radio resource control (RRC) reconfiguration message that includes a route identifier, E2E radio bearer information, PC5 radio link control (RLC) channel configuration information, and sidelink relay adaptation protocol (SRAP) configuration information, wherein the E2E radio bearer information includes a radio bearer identifier and sidelink service data adaptation protocol configuration information.
Aspect 27: The method of Aspect 26, further comprising transmitting, to another relay UE or the destination UE, another sidelink RRC reconfiguration message that includes the route identifier, the E2E radio bearer information, the PC5 RLC channel configuration information, and the SRAP configuration information.
Aspect 28: A method of wireless communication performed by a remote user equipment (UE), comprising: transmitting, to a relay UE, an end-to-end (E2E) quality of service associated with a link between the remote UE and another remote UE and a route identifier associated with the link between the remote UE and the other remote UE; receiving, from the relay UE, a per-hop quality of service associated with a link between the remote UE and the relay UE; and providing, by a proximity services layer of the remote UE to an access stratum layer of the remote UE, the per-hop quality of service.
Aspect 29: The method of Aspect 28, wherein the remote UE is a source UE and the other remote UE is a destination UE.
Aspect 30: The method of any of Aspects 28-29, further comprising determining the E2E quality of service and the route identifier based at least in part on a proximity services layer discovery process.
Aspect 31: The method of any of Aspects 28-30, wherein transmitting the E2E quality of service comprises transmitting a Layer 3 (L3) communication that includes an indication of the E2E quality of service, and wherein receiving the per-hop quality of service comprises receiving another L3 communication that includes an indication of the per-hop quality of service.
Aspect 32: The method of Aspect 31, further comprising configuring, by the access stratum layer of the remote UE, one or more sidelink radio bearers based at least in part on the per-hop quality of service.
Aspect 33: The method of any of Aspects 28-32, wherein transmitting the E2E quality of service comprises transmitting a Layer 2 (L2) communication that includes an indication of the E2E quality of service, and wherein receiving the per-hop quality of service comprises receiving another L2 communication that includes an indication of the per-hop quality of service.
Aspect 34: The method of Aspect 33, wherein transmitting the E2E quality of service comprises transmitting a sidelink PC5 (PC5-S) link modification request message, wherein the PC5-S link modification request message includes E2E quality of service flow information associated with the E2E quality of service and the route identifier.
Aspect 35: The method of Aspect 34, wherein receiving the per-hop quality of service comprises receiving, from the relay UE, a PC5-S link modification response message that includes the E2E quality of service flow information and an indication of the per-hop quality of service.
Aspect 36: The method of Aspect 33, wherein transmitting the E2E quality of service comprises transmitting a sidelink radio resource control (RRC) reconfiguration message, wherein the sidelink RRC reconfiguration message includes E2E quality of service flow information associated with the E2E quality of service and the route identifier.
Aspect 37: The method of Aspect 36, wherein receiving the per-hop quality of service comprises receiving, from the relay UE, a sidelink RRC reconfiguration complete message that includes the E2E quality of service flow information and the indication of the per-hop quality of service.
Aspect 38: The method of any of Aspects 28-37, further comprising determining, by the access stratum layer of the remote UE, radio link control or medium access control configuration information based at least in part on the per-hop quality of service received by the proximity services layer of the remote UE.
Aspect 39: The method of Aspect 38, further comprising determining a PC5 radio link control channel configuration that includes the radio link control or medium access control configuration information.
Aspect 40: The method of any of Aspects 28-39, further comprising determining a sidelink relay adaptation protocol configuration that includes the route identifier or a sidelink radio bearer to PC5 radio link control channel identifier mapping.
Aspect 41: The method of any of Aspects 28-40, further comprising transmitting, to the relay UE, sidelink data adaptation protocol information for assisting with quality of service flow identification by the relay UE.
Aspect 42: The method of any of Aspects 28-41, further comprising transmitting, to the relay UE, PC5 radio link control channel configuration information and sidelink relay adaptation protocol configuration information.
Aspect 43: The method of any of Aspects 28-42, further comprising transmitting, to the relay UE, a sidelink radio resource control reconfiguration message that includes a route identifier, E2E radio bearer information, PC5 radio link control channel configuration information, and sidelink relay adaptation protocol configuration information, wherein the E2E radio bearer information includes a radio bearer identifier and sidelink data adaptation protocol configuration information.
Aspect 44: An apparatus for wireless communication at a device, comprising a processor; memory coupled with the processor; and instructions stored in the memory and executable by the processor to cause the apparatus to perform the method of one or more of Aspects 1-43.
Aspect 45: A device for wireless communication, comprising a memory and one or more processors coupled to the memory, the one or more processors configured to perform the method of one or more of Aspects 1-43.
Aspect 46: An apparatus for wireless communication, comprising at least one means for performing the method of one or more of Aspects 1-43.
Aspect 47: A non-transitory computer-readable medium storing code for wireless communication, the code comprising instructions executable by a processor to perform the method of one or more of Aspects 1-43.
Aspect 48: A non-transitory computer-readable medium storing a set of instructions for wireless communication, the set of instructions comprising one or more instructions that, when executed by one or more processors of a device, cause the device to perform the method of one or more of Aspects 1-43.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a relay user equipment (UE), comprising:
a memory; and
one or more processors, coupled to the memory, configured to:
receive, from a source UE, an end-to-end (E2E) quality of service associated with a link between the source UE and a destination UE;
identify, based at least in part on the E2E quality of service, a first per-hop quality of service to be used for a link between the source UE and the relay UE, and a second per-hop quality of service to be used for one or more other links; and
transmit an indication of the first per-hop quality of service or the second per-hop quality of service.

2. The apparatus of claim 1, wherein the one or more processors, to identify the first per-hop quality of service and the second per-hop quality of service, are configured to split an E2E quality of service amount into a first per-hop quality of service amount to be used for the link between the source UE and the relay UE and a second per-hop quality of service amount to be used for the one or more other links.

3. The apparatus of claim 1, wherein a next-hop UE is the destination UE, and wherein identifying the second per-hop quality of service comprises identifying a second per-hop quality of service to be used for a link, of the one or more other links, between the relay UE and the destination UE.

4. The apparatus of claim 1, wherein a next-hop UE is another relay UE, and wherein identifying the second per-hop quality of service comprises identifying a second per-hop quality of service to be used at least for a link, of the one or more other links, between the relay UE and the other relay UE, and for a link, of the one or more other links, between the other relay UE and the destination UE.

5. The apparatus of claim 1, wherein receiving the E2E quality of service comprises receiving a sidelink signaling message over a per-hop unicast link that includes an indication of the E2E quality of service, and wherein transmitting the indication of the first per-hop quality of service or the second per-hop quality of service comprises transmitting another sidelink signaling message over a per-hop unicast link that includes the indication of the first per-hop quality of service or the second per-hop quality of service.

6. The apparatus of claim 5, wherein the one or more processors are further configured to configure a per-hop flow PC5 quality of service parameter to meet an E2E quality of service requirement during a per-hop unicast link setup or a per-hop unicast link modification.

7. The apparatus of claim 5, wherein the one or more processors, to identify the first per-hop quality of service and the second per-hop quality of service, are configured to identify the first per-hop quality of service and the second per-hop quality of service based at least in part on a link quality, a load condition of a next-hop UE, and a number of hops.

8. The apparatus of claim 5, wherein the one or more processors, to identify the first per-hop quality of service or the second per-hop quality of service, are configured to:
determine a packet delay budget split for each hop; or
identify the first per-hop quality of service and the second per-hop quality of service based at least in part on a processing delay requirement, or a load condition associated with the relay UE.

9. The apparatus of claim 5, wherein the one or more processors are further configured to:
provide an indication of the first per-hop quality of service; and
configure one or more sidelink radio bearers, based at least in part on the first per-hop quality of service.

10. The apparatus of claim 5, wherein receiving the sidelink signaling message over a per-hop unicast link comprises receiving a sidelink PC5 (PC5-S) link modification request message, wherein the PC5-Slink modification request message includes E2E quality of service flow information associated with the E2E quality of service and at least one of a route identifier or user information associated with the source UE and the destination UE.

11-13. (canceled)

14. The apparatus of claim 1, wherein a proximity services layer associated with the relay UE sends an indication of the first per-hop quality of service to an access stratum layer of the relay UE.

15. (canceled)

16. An apparatus for wireless communication at a remote user equipment (UE), comprising:
a memory; and
one or more processors, coupled to the memory, configured to:
transmit, to a relay UE, an end-to-end (E2E) quality of service associated with a link between the remote UE and another remote UE and a route identifier associated with the link between the remote UE and the other remote UE;
receive, from the relay UE, a per-hop quality of service associated with a link between the remote UE and the relay UE; and
provide, by a proximity services layer of the remote UE to an access stratum layer of the remote UE, the per-hop quality of service.

17. The apparatus of claim 16, wherein the remote UE is a source UE and the other remote UE is a destination UE.

18. The apparatus of claim 16, wherein the one or more processors are further configured to determine the E2E quality of service and the route identifier based at least in part on a proximity services layer discovery process.

19. The apparatus of claim 16, wherein transmitting the E2E quality of service comprises transmitting a Layer 3 (L3) communication that includes an indication of the E2E quality of service, and wherein receiving the per-hop quality of service comprises receiving another L3 communication that includes an indication of the per-hop quality of service.

20. The apparatus of claim 19, wherein the one or more processors are further configured to configure one or more sidelink radio bearers based at least in part on the per-hop quality of service.

21. The apparatus of claim 16, wherein transmitting the E2E quality of service comprises transmitting a Layer 2 (L2) communication that includes an indication of the E2E quality of service, and wherein receiving the per-hop quality of service comprises receiving another L2 communication that includes an indication of the per-hop quality of service.

22-25. (canceled)

26. The apparatus of claim 16, wherein the one or more processors are further configured to determine radio link control or medium access control configuration information based at least in part on the per-hop quality of service received by the proximity services layer of the remote UE.

27. The apparatus of claim 16, wherein the one or more processors are further configured to determine a sidelink relay adaptation protocol configuration that includes the route identifier or a sidelink radio bearer to PC5 radio link control channel identifier mapping.

28. The apparatus of claim 16, wherein the one or more processors are further configured to transmit, to the relay UE, sidelink data adaptation protocol information for assisting with quality of service flow identification by the relay UE.

29-30. (canceled)
